(19) United States
(12) Patent Application Publication
(10) Pub. No.: US 2022/0315052 A1
(43) Pub. Date: Oct. 6, 2022

(54) CONTINUOUS SAFETY ADAPTION FOR VEHICLE HAZARD AND RISK ANALYSIS COMPLIANCE

(71) Applicant: Intel Corporation, Santa Clara, CA (US)

(72) Inventors: Fabian OBORIL, Karlsruhe (DE); Cornelius BUERKLE, Karlsruhe (DE); Frederik PASCH, Karlsruhe (DE)

(21) Appl. No.: 17/847,309

(22) Filed: Jun. 23, 2022

(51) Int. Cl. B60W 60/00; B60W 30/095; B60W 40/04; B60W 50/00

(52) U.S. Cl. CPC B60W 60/0011; B60W 60/0015; B60W 60/00274; B60W 30/0956; B60W 40/04; B60W 50/0097; B60W 2050/0083; B60W 2556/10

(57) ABSTRACT

Disclosed herein are systems, devices, and methods for hazard and risk analysis systems that use operational information about an autonomous vehicle in order to continuously determine a hazard and risk analysis of a vehicle and its compliance with safety standards. The hazard and risk analysis system estimates a hazard probability for a vehicle based on operational information about the vehicle, wherein the hazard probability represents a likelihood that the vehicle will experience a driving event over a predefined interval. The hazard and risk analysis also adjusts a driving parameter of the vehicle based on the hazard probability if the hazard probability deviates from a predefined hazard safety criterion.

### TECHNICAL FIELD

The disclosure relates generally to vehicle safety systems, and in particular, to systems, devices, and methods for continuously evaluating the hazard and risk compliance of a vehicle.

### BACKGROUND

As vehicles become more autonomous, moving from partially autonomous to fully autonomous, ensuring that autonomous vehicles comply with vehicle safety standards becomes more important. Many governments and municipalities set forth safety standards with which vehicles, including autonomous vehicles, must prove compliance before the vehicle is allowed to participate in traffic. A certification may be required by which vehicle manufacturers must prove compliance with the safety standards (e.g., homologation). Such safety standards may include, for example, functional safety standards for automobiles (e.g., ISO 26262, entitled “Road Vehicles—Functional Safety” and defined by the International Organization for Standardization (ISO) in 2011 and revised in 2018; and ISO 21448, entitled “Road Vehicles—Safety of the Intended Functionality” and defined by ISO in 2019 and revised in 2020). Such standards often require that the manufacturers of vehicles provide evidence that their vehicles are safe enough to operate in normal traffic. In essence, this means that a hazard and risk analysis may be performed to determine whether the occurrence rate of a critical driving event (e.g., a catastrophic failure, a crash, an accident, etc.) is below an acceptable threshold.

By some estimates, autonomous vehicles (AVs) may be expected to operate at least as safely as the average human driver, which means a target failure rate of approximately one accident every 105 hours or approximately one accident every 107 kilometers. Given the practical inability to obtain sufficient empirical data to certify an AV, manufacturers may use statistical estimates to show compliance of an AV to the target failure rate. Such statistical models, however, may involve imperfect estimates for how often a hazardous traffic situation may occur, how often a perception error may occur, or how often a planning, control, or how often other subsystem of the AV may fail, leading to AV systems that may be underperforming or overperforming with respect to compliance with the relevant safety standards.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary aspects of the disclosure are described with reference to the following drawings, in which:

FIG. 1 shows an exemplary fault tree for estimating the hazard/risk safety of a vehicle based on various occurrence probabilities;

FIG. 2 shows an exemplary system for continuously evaluating the hazard/risk safety of a vehicle based on operational information of the vehicle;

FIG. 3 illustrates an exemplary system for continuously evaluating the hazard/risk safety of a vehicle based on operational information of the vehicle;

FIG. 4 illustrates an exemplary plot of a dependency function for a driving parameter of a vehicle;

FIGS. 5A-5B illustrates an exemplary perception system that may fuse together information from numerous sensors and/or numerous sensor types with overlapping field of view;

FIG. 6 illustrates exemplary plots of the expected number of objects detected verses frequency for two different sensors/sensor modalities of a vehicle;

FIG. 7 illustrates exemplary plots of the distribution of expected occurrence probability versus speed that one of three different driving scenarios may occur;

FIG. 8 illustrates exemplary plots of the distribution of expected occurrence probability versus speed that a vehicle will operate with a given speed;

FIG. 9 illustrates an exemplary schematic drawing of a device continuously evaluating the hazard/risk safety of a vehicle; and

FIG. 10 depicts a schematic flow diagram of an exemplary method for continuously evaluating the hazard/risk safety of a vehicle.

### DESCRIPTION

The following detailed description refers to the accompanying drawings that show, by way of illustration, exemplary details and features.

The word “exemplary” is used herein to mean “serving as an example, instance, or illustration.” Any aspect or design described herein as “exemplary” is not necessarily to be construed as preferred or advantageous over other aspects or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . .], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in the form of a pointer. The term “data”, however, is not limited to the aforementioned examples and may take various forms and represent any information as understood in the art.

The terms “processor” or “controller” as, for example, used herein may be understood as any kind of technological entity (e.g., hardware, software, and/or a combination of both) that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, software, firmware, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

A “vehicle” may be understood to include any type of machinery that may be operated by software, including autonomous, partially autonomous, stationary, moving, or other objects or entities that utilize software as part of their operation. By way of example, a vehicle may be a driven object with a combustion engine, a reaction engine, an electrically driven object, a hybrid driven object, or a combination thereof. A vehicle may be or may include an automobile, a bus, a mini bus, a van, a truck, a mobile home, a vehicle trailer, a motorcycle, a bicycle, a tricycle, a train locomotive, a train wagon, a robot, a personal transporter, a boat, a ship, a submersible, a submarine, a drone, an aircraft, industrial machinery, autonomous or partially autonomous machinery, or a rocket, among others.

As vehicles have become more autonomous, vehicle safety systems have become more complex such that it is increasingly important to evaluate the safety of autonomous vehicles before they are allowed to regularly participate in traffic. International safety standards have been developed for evaluating the functional safety and the safety of intended functionality of vehicles, including for example, ISO 26262 (“Road Vehicles—Functional Safety”) and ISO 21448 (“Road Vehicles—Safety of the Intended Functionality”). Such standards often require that the manufacturers of vehicles provide evidence that their vehicles are safe enough to operate in normal traffic. In essence, this means that a hazard and risk analysis may be performed to determine whether the occurrence rate of a critical driving event (e.g., a catastrophic failure, a crash, an accident, etc.) is below an acceptable threshold. For newly developed autonomous vehicles, however, occurrence rates may be difficult to estimate, given the lack of empirical data. As a result, imperfect estimates for how often a hazardous traffic situation may occur, how often a perception error may occur, or how often a planning, control, or other subsystem of the AV may fail. Imperfect estimates may mean that a given AV may be underperforming or overperforming with respect to the relevant safety standards.

As should be appreciated from the description below, the disclosed hazard and risk analysis system may continuously evaluate the hazard/risk safety of an autonomous vehicle using actual operational information of the vehicle and adapt the driving parameters of the AV to achieve a target level of safety. As a result, the AV may continuously adapt its behavior to its operating conditions such that the AV may in real time comply with safety standard targets (e.g., as required by the safety standards) for the hazard/risk safety of the vehicle.

This is in contrast to conventional ways of proving compliance with safety standard targets, where manufacturers may use statistical models to simply estimate the probability that the autonomous vehicle will encounter a hazardous situation (e.g. a situation requiring insights from a perception system and reactionary adjustments to the vehicle operation by a driving decision and/or control system) multiplied by the probability that either the perception system fails or the driving decision and/or control system fails, resulting in an estimated likelihood that a critical driving event (e.g., a crash) occurs over a given time period. For example, a conventional statistical model may estimate that an AV will be in hazardous situations only for 10% of its total driving time and its relevant perception/safety systems will encounter an error only 0.001% of the time. Using these estimates, the expected number of critical driving events over 105 hours of driving would be (105×0.1×0.001)=1.

However, these estimates may not necessarily reflect the reality of a particular vehicle's day-to-day driving experiences, which means that these likelihoods may vary over time, differ from vehicle to vehicle, and may depend on the driving environment. Factors that may influence, for example, the likelihood that a vehicle will encounter a hazardous situation may include traffic density, traffic flow, time of day, geographic location, climate, geography, road topology, weather patterns, etc., all of which may fluctuate over time. As a result, the vehicle may in reality have a much higher likelihood that it will encounter a hazardous situation (e.g., the vehicle more often than expected travels in rush hour traffic in a rainy climate with curvy roads; the vehicle operates at nighttime more often than expected; etc.) or a much lower likelihood that it will encounter a hazardous situation (e.g., the vehicle makes more often than expected trips along the same route in a dry climate with wide roads; the vehicle operates only in the daytime; etc.). If the estimate for the likelihood the vehicle encounters a hazardous situation is incorrect, the safety certification may no longer be valid (e.g., if the estimate is lower than in actuality) or the vehicle's safety system may be overly conservative (e.g., if the estimates are higher than in actuality).

Unlike conventional statistical models, the disclosed hazard and risk analysis system may observe operational information of the vehicle and the environment in which the vehicle is operating to continuously adjust the probabilities used to estimate hazard/risk safety and to continuously adjust its safety-relevant driving parameters (e.g., following distances, driving speed, operational domains, etc.) to ensure the estimated hazard/risk safety continuously meets the target value(s) (e.g., no more than one accident every 105 hours). Such a continuous estimate of hazard/risk safety may be performed in real-time using operational information from the vehicle. In addition, the estimated hazard/risk safety may be reported to the vehicle owner, the vehicle manufacturer, the vehicle service provider, etc., who can then continuously monitor the vehicle's safety performance and make updates accordingly (e.g., provide new software releases).

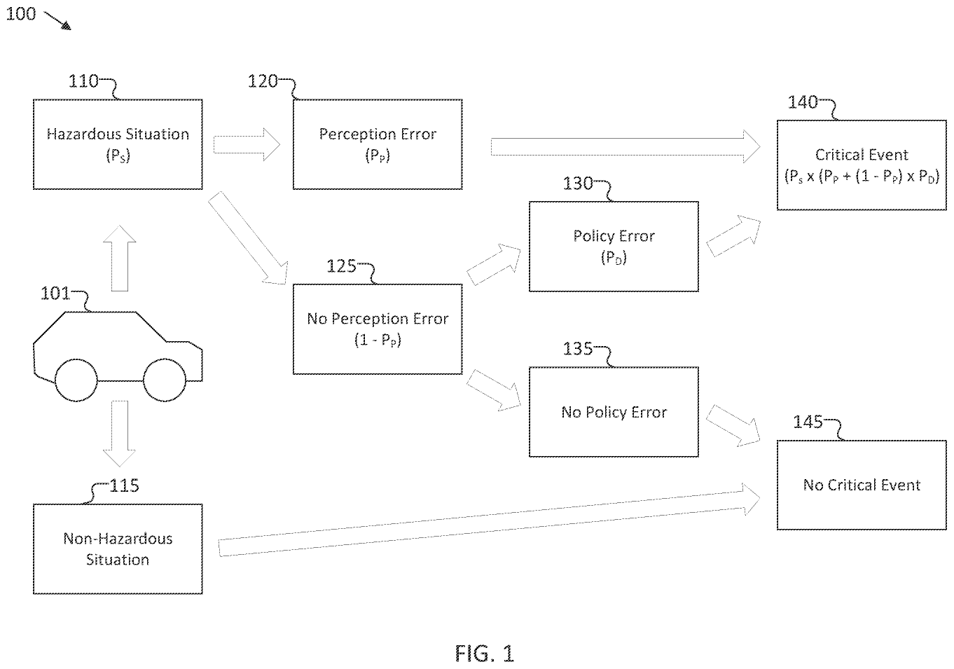

FIG. 1 shows an exemplary fault-tree 100 that may be used for estimating the hazard/risk safety of an autonomous vehicle based on various estimates of occurrence probabilities. FIG. 1 shows how the probability that a vehicle may encounter a hazardous traffic situation and the probabilities of relevant system errors may be used to determine an estimated occurrence value for the number of critical events (e.g., a catastrophic failure, a crash, an injury, a breakdown, etc.) for a given period. For example, during operation, an autonomous vehicle may continue operating with the current operating parameters until it encounters a situation that requires some change to one or more of its current operating parameters. If the vehicle fails to make the necessary change(s) to its operating parameters, it may result in a critical event. Depending on the type of situation (e.g., driving at high speeds, curvy roads, high traffic congestion), the likelihood may increase or decrease that the vehicle's failure results in a critical event.

With reference to FIG. 1, vehicle 101 may encounter situations such as a non-hazardous situation 115, where vehicle 101 may continue operating with the current operating parameters without a critical event occurring (e.g., no critical event 145), or other situations such as a hazardous situation 110, where the vehicle 101 may need to adjust an operating parameter (e.g., brake, turn, decelerate, etc.). If the adjustment does not occur correctly, a critical event may occur (e.g., critical event 140). As should be understood, hazardous situation 110 may also consist of a smaller subset of situations that depend on the current operating parameters of the vehicle and/or the extent of adjustment that must be made to the operating parameters. This may include situations, for example, that require extreme braking, situations where the vehicle 101 is maintaining a close following distance to a vehicle ahead, situations where vehicle 101 is traveling at a high velocity, etc. One example of a situation that may be classified as hazardous situation 110 may be if vehicle 101 is driving on a highway at a speed of more than 100 km/h with a following distance to the next vehicle ahead of only a few meters. In addition, whether the situation is classified as a hazardous situation 110 or a non-hazardous situation 115 may depend on the current environmental conditions of the vehicle 101 (e.g., weather, road type, traffic density, operational design domain, etc.).

Because hazardous situation 110 may require a change to the operating parameter(s) of vehicle 101, the autonomous driving system of vehicle 101 must respond correctly to the situation, typically using a perception system for sensing the environment and a policy system for determining and executing the operational parameter change. If there is no perception error (e.g., 125) in the perception system and no policy error (e.g., 135) in the policy system, the autonomous driving system of vehicle 101 may respond correctly, and the vehicle 101 likely encounters no critical event (145). However, if there is a perception error 120, or if there is no perception error 125 but there is a policy error 130, the autonomous driving system of the vehicle 101 may not respond correctly and critical event 140 occurs. As should be appreciated, while only three branches of fault-tree 100 have been shown (corresponding to hazardous situation, perception error, and policy error), any number of branches may be used to model the various potential faults, depending on the number of modeled subsystems or fault sources.

By applying probabilities to each branch of the fault-tree 100, a probability of occurrence of a critical event 140 may be estimated. For example, vehicle 101 may find itself with a certain probability (P_{S} or situational probability) in a hazardous situation 110. Often, P_{S} may be estimated from off-line data (e.g., from pre-deployment estimates, crowd-sourced historical data, or other non-vehicle specific sources).

Assuming the vehicle encounters a hazardous situation 110, there is also a probability that a relevant perception error 120 occurs (P_{P} or perception quality rating) or a probability that no relevant perception error 125 occurs (1−P_{P}). A relevant perception error 120 may be any type of error that impacts the driving system to such an extent that it responds incorrectly to the situation and likely causes the critical event 140. For example, a perception error 120 may occur where the perception system missed detection of the leading vehicle traveling ahead of vehicle 101 or where the perception system significantly overestimated the velocity of the leading vehicle.

Assuming there is no relevant perception error 125, the likelihood of a critical event 140 may also depend on a probability that a policy error 130 occurs (P_{D}, or policy error rate). A policy error 130 may be understood as any failure of the decision and/or control system of the vehicle 101 that responds to the hazardous situation 110, thus resulting in critical event 140 occurring. For example, the decision and/or control system may use parametric policies that provide for a maximum allowable speed, a minimum allowable distance to a proximate object, a maximum allowable change in acceleration, a maximum allowable braking force, an allowable technique of a lane change, etc. If any of these parametric policies are violated, the vehicle 101 may have acted/reacted differently that predicted, and thus result in a policy error. For example, a policy error 130 may include a failure to brake with the required deceleration, a failure to sufficiently turn the wheel when the road curves, a failure to fully stop at a red light, accelerating in excess of the maximum acceleration on a slippery road, etc.

In addition, a policy error 130 may include errors in the predictions made about vehicle 101 (e.g., mis-predictions about how the vehicle 101 is expected to act/react to a given operating command) or in the predictions made about other objects/vehicles (e.g., how other objects may act/react to a constellation of traffic objects/events in a given situation). For example, the decision and/or control system of the vehicle 101 may have predicted that a leading vehicle in front of vehicle 101 would accelerate, but if the leading vehicle instead brakes, this would register as a policy error for a braking event (e.g., failed to predict a braking event or mis-predicted a non-braking event) and/or a policy error for an acceleration event (e.g., failed to predict a deceleration or mis-predicted an acceleration event). As another example, the decision and/or control system of the vehicle 101 may predict that movement of a nearby vehicle indicates a lane change, but if the nearby vehicle remains in the same lane, this would register as a policy error for a lane change event (e.g., mis-predicted a lane change event or failed to predict a remain-in-lane event).

Taking each of these factors into account, the overall failure probability of an occurrence of a critical event 140 may be expressed as:

P_{S}×(P_{P}+(1−P_{P})×P_{D}).

As should be appreciated, FIG. 1 is only exemplary, and the failure-tree 100 may include more complex branching by, for example, dividing the failure-tree 100 into multiple subtrees for different operational and environmental conditions of the vehicle, by modeling additional systems or failure points, or by using a different failure model (e.g., a stochastic activity networks (SAN)). Irrespective of the branching or failure model used, the input data may be similar, including operational information (e.g., how the vehicle is expected to operate) to derive P_{S} and information about the perception quality (e.g., expected sensor accuracy, sensor precision, sensor redundancy, etc.) to obtain P_{P} and driving policy errors (e.g., expected decision accuracy, control precision, etc.) to obtain P_{D}.

Among other factors that may be relevant to determining a vehicle's situational probability P_{S}, some examples include: distribution of driving speeds (occurrence and duration); distribution of following distances (occurrence and duration); distribution of braking or acceleration events (occurrence, strength, duration, etc.); and distribution of lane change or turning events (occurrent and duration).

Among other factors that may be relevant to determining a vehicle's perception quality rating P_{P}, some examples include: distribution of missed detections (false negatives) with respect to duration and occurrence; distribution of false alarms (false positives) with respect to duration and occurrence; and distribution of velocity or distance errors with respect to duration and occurrence.

Among other factors that may be relevant to determining a vehicle's policy error rate P_{D}, some examples include: distribution of mis-predicted braking or acceleration events (occurrence, strength, duration, etc.); distribution of mis-predicted lane change (occurrence, duration, etc.); and distribution of other violations (occurrence, duration, etc. of failures or mis-predications) of any policy parameter (expected minimum distance to an object, expected maximum velocity, etc.).

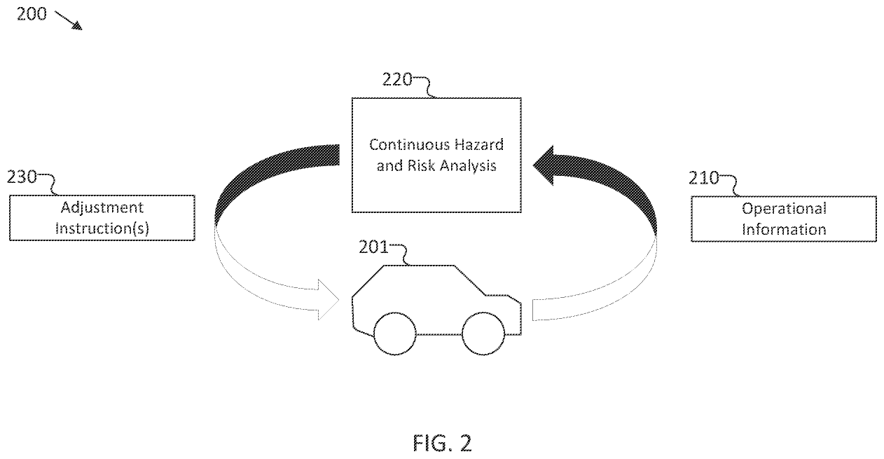

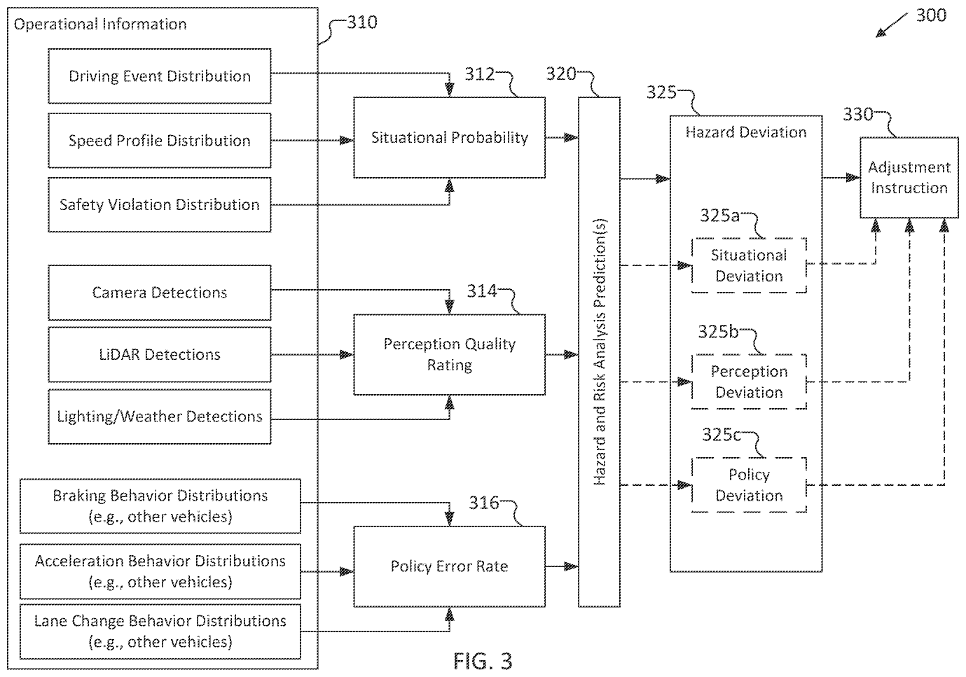

Of course, as noted above, if these factors are estimated based on off-line data or based on anticipated operating conditions, these estimates may be inaccurate when considering the actual conditions experienced by a given vehicle. And if certification of the vehicle with respect to relevant safety standards was based on inaccurate assumptions, this may result in a vehicle that is underperforming or overperforming with respect to those safety standards. To overcome this potential inaccuracy, the disclosed hazard and risk analysis system, discussed in more detail below with respect to, e.g., FIGS. 2 and 3, may use actual operational information of the vehicle to continuously evaluate the hazard/risk safety of an autonomous vehicle and adapt the driving parameters of the vehicle to achieve a target level of safety. This may ensure that the vehicle continuously satisfies the relevant safety standards with the desired degree of target compliance.

FIG. 2 shows a high-level view of an exemplary hazard and risk analysis system 200 that uses operational information 210 about the vehicle 201 for a continuous hazard and risk analysis 220 of a vehicle 201 (e.g., an autonomous vehicle). Unlike conventional statistical models, the hazard and risk analysis system 200 may collect operational information 210 about the vehicle 201 and the environment in which the vehicle 201 is operating in order to inform the continuous hazard and risk analysis 220. In this manner, the hazard and risk analysis system 200 may adjust the way in which it derives the relevant probabilities (e.g., P_{S} , P_{P} , and P_{D}) for estimating a hazard/risk safety of the vehicle 201. In addition, the hazard and risk analysis system 200 may continuously generate adjustment instruction(s) 220 for adjusting safety-relevant driving parameters of the vehicle 201 (e.g., following distances, driving speed, operational domains, etc.) to ensure that the estimated hazard/risk safety continuously meets a predefined target value (e.g., a desired degree to which a safety standard is satisfied).

As should be appreciated, continuous hazard and risk analysis 220 may be performed at the vehicle 201 (e.g., in a processor internal to vehicle 201), at a location remote from the vehicle 201 (e.g., in a processor on a cloud-based or edge-based server), or distributed among multiple processing locations (e.g., different processors that may be located on and/or off of vehicle 201). As should be appreciated, the operational information 210 may be collected from sensors on the vehicle 201, sensors external to the vehicle 201, and/or may be received in messages from other vehicles, infrastructure equipment, mobile sensors, etc. using wireless transmissions (e.g., using a communication protocol of a wireless receiver). As should also be appreciated, if the adjustment instruction(s) 230 are generated off-vehicle, they may be transmitted to vehicle 201 using wireless transmissions (e.g., using a communication protocol of a wireless transmitter).

FIG. 3 shows a high-level view of an exemplary hazard and risk analysis system 300 for the continuous hazard and risk analysis of a vehicle based on operational information about the vehicle. FIG. 3 may be an exemplary implementation of the hazard and risk analysis system 200 described above with respect to FIG. 2 for vehicle 201. As should be appreciated, however, the details of FIG. 3 are not intended to be limiting on FIG. 2.

The hazard and risk analysis system 300 may determine a situational probability 312 (e.g., situational probability P_{S}), a perception quality rating 314 (e.g., perception quality rating P_{P}), and/or a policy error rate 316 (e.g., policy error rate P_{D}) based on any type of operational information 310 about the vehicle and its operating environment. For example, hazard and risk analysis system 300 may observe driving events of the vehicle in order to determine a distribution of actual driving events (e.g., occurrence, duration, etc. of breaking events, accelerating events, constant speed events, lane change events, intersection crossing/turning events, etc.), observe speed profiles of the vehicle in order to determine a distribution of speed profiles (e.g., occurrence, duration, etc.), and/or observe safety violations to determine a distribution of safety violations (e.g., occurrence, type, severity, duration, etc. of unsafe following distances, speeds faster than a maximum speed, accelerations/decelerations that are faster than permitted for the environment, etc.). This operational information 310 may then be used to determine situational probability 312, where the situational probability 312 may be the situational probability (P_{S}) discussed above (e.g., the probability that the vehicle will encounter a hazardous situation (e.g. a situation that may require a changed operating parameter and insights from a perception system and/or a policy system to determine how to react and to carry out the reaction on the vehicle). As should be appreciated, the situational probability 312 may be based on any type of operational information 310, and the examples shown in FIG. 3 and discussed above with respect to P_{S} are not intended to be limiting.

To determine perception quality rating 314, the hazard and risk analysis system 300 may use any type of operational information 310 about the vehicle and its operating environment. For example, hazard and risk analysis system 300 may utilize sensor data to observe information about objects detected by a camera (e.g., number, duration, classification, etc. of detections, missed detections (false negatives), false alarms (false positives), etc.), information about objects detected by a light ranging and detection (LiDAR) system, information about environmental conditions (e.g., number, duration, classification, etc. of determined light conditions, weather conditions, road conditions, etc.) to determine a distribution of environmental conditions. This operation information 310 may then be used to determine perception quality rating 314, where the perception quality rating 314 may be the perception quality rating (P_{P}) discussed above (e.g., the probability that a relevant perception error occurs). As should be appreciated, the perception quality rating 314 may be based on any type of operational information 310, and the examples shown in FIG. 3 and discussed above with respect to P_{P} are not intended to be limiting.

To determine policy error rate 316, the hazard and risk analysis system 300 may use any type of operational information 310 about the vehicle and its operating environment. For example, hazard and risk analysis system 300 may utilize information about parametric policies (e.g., predictions/assumptions for how the vehicle or other objects in the environment are expected to act/react) in order to observe instances where the parametric policy may have been violated or resulted in a failed prediction (e.g., number, duration, extent of failed or mis-predicted braking events of other vehicles, acceleration events of an approaching object, lane change events of other vehicles, failed or mis-predicted estimated braking force caused the vehicle to exceed a maximum allowable acceleration/deceleration, etc.). This operation information 310 may then be used to determine policy error rate 316, where the policy error rate 316 may be the policy error rate (P_{D}) discussed above (e.g., the probability that a policy error occurs when acting/reacting to a situation). As should be appreciated, the policy error rate 316 may be based on any type of operational information 310, and the examples shown in FIG. 3 and discussed above with respect to P_{D} are not intended to be limiting.

Once the hazard and risk analysis system 300 has determined the situational probability 312 (e.g., situational probability P_{S}), the perception quality rating 314 (e.g., perception quality rating P_{P}), and/or the policy error rate 316 (e.g., policy error P_{D}), the hazard and risk analysis system 300 may use any or all of these values to determine (e.g. in 320) the overall probability of a critical event, using, for example, the formula discussed above: P_{S}×(P_{P}+(1−P_{P})×P_{D}). As should be appreciated, determining the overall probability of a critical event for the vehicle need not follow this formula, and the hazard and risk analysis system 300 may use any formula/model (e.g., as one example, using different weightings for each factor) for determining the overall probability of a critical event for the vehicle based on situational probability 312, the perception quality rating 314, and/or the policy error rate 316.

Next, the hazard and risk analysis system 300 may determine a hazard deviation 325 based on the overall probability of a critical event compared to a target value or range of target values (e.g., a predefined target). If the overall probability of a critical event is defined as λ_{pred} and the target safety value is defined as λ_{target}, then the deviation may be expressed as |λ_{pred}λ_{target}|. If the deviation exceeds a predefined threshold (δ), which may be expressed as |λ_{pred}−λ_{target}|>δ, the vehicle may no longer be compliant with its predefined target (e.g., and therefore its target safety certification level). As a result, the hazard and risk analysis system 300 may generate an adjustment instruction for adjusting one or more operating parameters of the vehicle so that the deviation no longer exceeds its predefined threshold (e.g., and therefore the vehicle will return to compliance with its target safety value and certification level).

On the other hand, if the deviation is well below the predefined threshold (δ), the vehicle may be overperforming with respect to safety, meaning that other systems may be underperforming (e.g., the maximum speed is too restrictive). As a result, the hazard and risk analysis system 300 may generate an adjustment instruction for adjusting one or more operating parameters of the vehicle so that the deviation returns closer to (and does not exceed) the predefined threshold so that other systems may operate more efficiently (e.g., the maximum speed may be increased while maintaining compliance with its target safety value and certification level).

In addition to the overall probability of a critical event, the determined hazard deviation 325 may include deviations of each of the individual factors used to calculate the overall probability of a critical event. Depending on the model used, this may include, for example, deviations of the situational probability 312, deviations of the perception quality rating 314, and/or deviations of the policy error rate 316. Each of these deviations (e.g., situational deviation 352a, perception deviation 325b, and policy deviation 325c) may be associated with its own target value or range of target values and may be used to generate an adjustment instruction for adjusting one or more operating parameters of the vehicle so that the respective deviation no longer exceeds its predefined target. For example, the estimation of the situational probability (X_{sit,pred}) may be compared to its target (X_{sit,target}) and thus determine its deviation (|X_{sit,pred}−X_{sit,target}|>δ_{X}_{ₛᵢₜ}); the estimation of perception error rating (X_{perc,pred}) may be compared to its target (X_{perc,target}) and thus determine its deviation (|X_{perc,pred}−X_{perc,target}|>δ_{X}_{_{perc}}); and/or the estimation of the policy error rate (X_{policy,pred}) may be compared to its target (X_{policy,target}) and thus determine its deviation (|X_{policy,pred}−X_{policy,target}|>δ_{X}_{_{policy}}).

As should be appreciated, it may be advantageous to predefine the target value(s), so that it provides sufficient margins for making parameter adjustments. If the predefined target value for the deviations is too small, the driving behavior may be adjusted too frequently or the adjustable parameters may not have sufficient precision to maintain the target deviation. If the target deviation is too large, this would allow vehicles to vary greatly from the safety standard, and compliance would not provide a meaningful measure of safety.

The hazard and risk analysis system 300 may continuously (e.g., at a predefined interval such as in real-time, periodically, randomly, or event-triggered) repeat this process of gathering (new) operational information 310, making (updated) hazard and risk analysis predications 320 based on the newly-gathered operational information 310, determining a hazard deviation 325, and generating an adjustment instruction 330 to ensure continuous compliance to the predefined target or predefined target range of safety. In this manner, the hazard and risk analysis system 300 may adjust the driving parameters of the vehicle in an adaptive manner, where the safer the vehicle (e.g., a lower estimated probability of a critical event), the more progressive/efficient it may drive (e.g. a higher maximum speeds, with reduced following distances, in bad-weather environments, etc.), and where the vehicle is less safe (e.g., a lower estimated probability of a critical event), more conservative driving parameters may be required (e.g., lower maximum speeds, longer following distances, restricted to good-weather environments, etc.).

The hazard and risk analysis system 300 may determine the adjustment instruction 330 using a lookup-table (e.g., containing off-line data, a priori simulation data, pre-deployment estimates, crowd-sourced data, etc.) to arrive at revised driving parameters (e.g. if the vehicle encounters a hazardous situation 10% more often than was predicted in the look-up table, increase safety margins by 5%), using fuzzy logic to arrive at revised driving parameters, or by any other means. As should be appreciated, such continuous adjustments allow for incremental adjustments to driving parameters, which may be preferred over a more drastic measure, such as an immediate stop or vehicle shutdown.

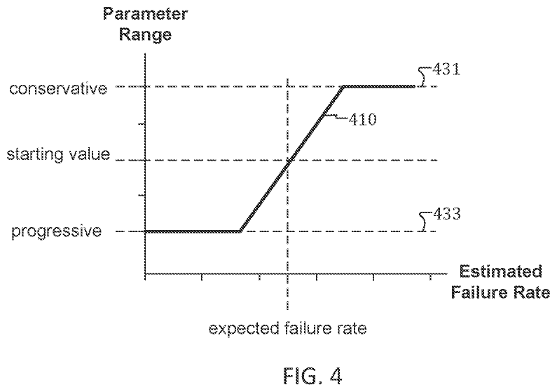

In this regard, the hazard and risk analysis system 300 may provide limits on the extent to which the hazard and risk analysis system 300 adapts a given driving parameter. In this manner, the hazard and risk analysis system 300 may limit the extent of the change (e.g., a maximum/minimum increment) and/or the maximums/minimums for a given parameter. This may be implemented using a dependency function that relates estimated failure rates to a range of available parameters, where the dependency function may limit the extent to which a driving parameter may be changed. An exemplary dependency function is shown in FIG. 4.

FIG. 4 shows a plot 400 of dependency function 410 that plots a given range of parameters (e.g., adjustable driving parameters of the vehicle) against estimated failure rates (e.g., the estimated overall probability of a critical event or other probability that may be monitored by a hazard and risk analysis system (e.g., hazard and risk analysis system 300)). Dependency function 410 may be used to limit the parameter range to a maximum value 431, a minimum value 433, and/or provide the incremental changes to apply (e.g., along curve 410) when the estimated failure rate deviates from the expected failure rate. Thus, when the estimated failure rate increases from an expected failure rate such that the parameter may be increased to a more conservative value (e.g., increasing the following distance), dependency function 410 may limit the parameter to the maximum value 431 (e.g., it will not adjust the following distance to be higher than a maximum setting for following distance). Similarly, when the estimated failure rate decreases from an expected failure rate such that the parameters may be decreased to a more progressive value (e.g., decreasing the following distance), dependency function 410 may limit the parameter to the minimum value 433 (e.g., it will not be adjusted below a minimum value for the following distance). In other words, even if the hazard and risk analysis system 300 determines the vehicle is driving with a lower failure rate than expected, it will not issue adjustment instructions that reduce the following distance below the minimum value 433. As should be appreciated, the dependency function 410 is merely exemplary, and it may have any shape and may or may not set maximums and/or minimums. As should also be appreciated, the hazard and risk analysis system may implement such dependency functions using a database of look-up tables, models, fuzzy logic, sigmoids, etc.

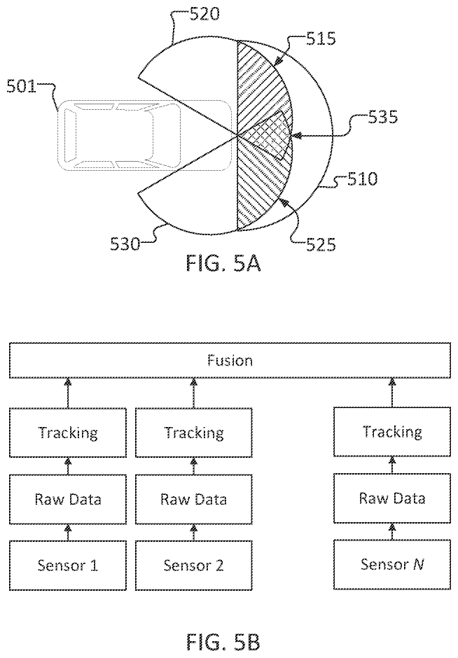

Returning to the discussion of estimating perception quality rating (e.g., estimating an occurrence frequency of perception errors), perception errors may be complex for the hazard and risk analysis system to determine accurately, especially where there is no absolute indicator of an error (e.g., there is no way to verify sensor information against ground truth information for what the sensor is measuring). To address this complexity, the hazard and risk analysis system may utilize information from redundant perception systems/sensors, where different aspects of the perception/sensor information may be combined/compared. For example, an autonomous vehicle may have a redundant sensor configuration and redundant perception algorithms, where multiple sensors may cover overlapping portions of the same field of view. As shown in FIG. 5A, for example, vehicle 501 may include three sensors, where a left side-facing sensor has a field of view 510, a front-facing sensor has a field of view 520, and a right side-facing sensor has a field of view 530. In such a configuration, there is an overlapping field of view 515 between field of view 510 and field of view 520; an overlapping field of view 525 between field of view 510 and field of view 530; and an overlapping field of view 535 among field of view 510, field of view 520, and field of view 530.

A common approach to combine the results of redundant perception systems is through fusion algorithms. A high-level example is shown in FIG. 5B, which uses fusion to collect sensor data from redundant perception channels (e.g., a first channel that uses raw data and tracking from sensor 1, a second channel that uses raw data and tracking from sensor 2, up to any number of additional N channels that uses raw data and tracking from sensor N). Such fusion algorithms often estimate a quality measure for the input coming from a specific input channel. As such, the hazard and risk analysis system may utilize such information to estimate the perception quality rating of the perception system.

In addition, the hazard and risk analysis system may compare object measurement information (e.g., number of objects, classification of objects, size of objects, etc.) that may be collected from each sensor with an overlapping field of view. Using FIG. 5A as an example, if an object is detected by a first sensor (e.g., the sensor associated with field of view 520) in an overlapping field of view 515, but the second sensor (e.g., the sensor associated with field of view 510) does not detect the object, the hazard and risk analysis system may determine that a perception failure has occurred (e.g., either a false negative at the second sensor or a false positive at the first sensor).

As should be appreciated, some deviations between different sensor's measurements—even in measurements of overlapping fields of view—may be expected for various reasons. For example, because the sensors may have different modalities or one sensor may be capable of covering a wider range and therefore is able to detect objects earlier. Of course, such deviations may be accounted for as part of the design and testing of the perception systems and associated error rates.

An example may be illustrative of how the hazard and risk analysis system may compare object measurement information to determine a perception error while also accounting for expected sensor differences. For example, a vehicle may have a perception system equipped with a LiDAR system and a camera system covering an overlapping field of view. As would be expected, the LiDAR system may be able to detect a higher number of objects at night than the camera system. For example, in dry conditions on a highway at night, a normal LiDAR system may detect up to 10% more objects than a normal camera system, and therefore, the deviation between the LiDAR system and the camera system during such a driving scenario may be expected to deviate by approximately 10%. Thus, the hazard and risk analysis system would not register such a deviation as a perception error or as impacting the perception quality rating. However, if under these same driving conditions, both systems provide a similar number of object detections, this might suggest a perception error (e.g., in the LiDAR system under-counting objects or in the camera system over-counting objects). In general, such characteristics may be obtained through testing, using offline databases that are capable of obtaining ground truth to verify an actual fault, thereby providing a correlation between input characteristics and a likely perception error.

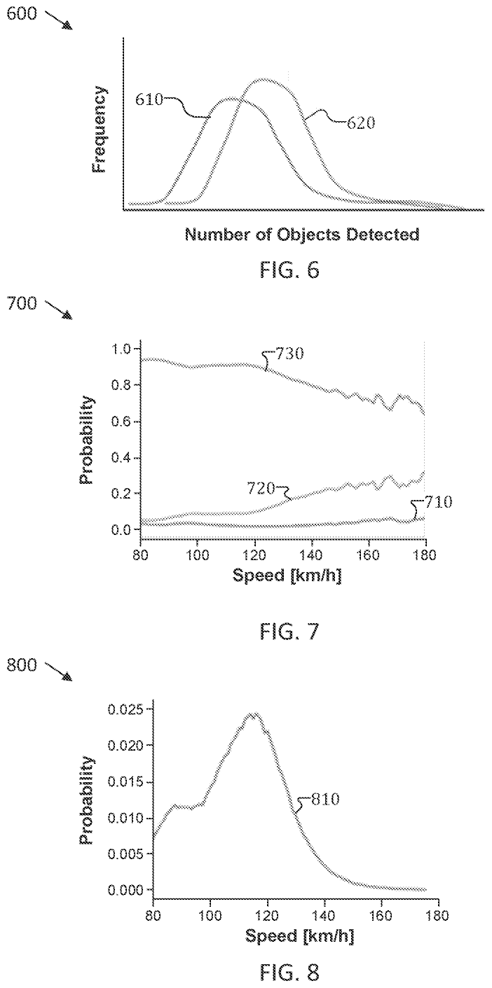

In comparing deviations, the hazard and risk analysis system may be based on distributions of the deviations over time, rather than a deviation at a single moment in time. This may provide an averaging effect, where even if the deviations from a single moment in time (e.g., a single frame) may vary from one measurement to the next, the distributions may exhibit a more stable result. For example, FIG. 6 illustrates a plot 600 of two example distributions where curve 610 may represent detections by a red-green-blue (RGB) camera system and curve 620 may represent detections by a LiDAR system, where the distributions are likely to be become stable after a certain amount of time, allowing the hazard and risk analysis system to make a comparison using equality tests (e.g. Kolmogorov-Smirnov-Test) or by comparing expected values, peaks, standard deviation, or other characteristics. Given that todays sensors often have a frame rate of more than 20 frames per second, this means that after 20 minutes, more than 20000 samples may be available for the distribution. Thus, even after a relatively short amount of time, the hazard and risk analysis system may have sufficient distribution data to estimate the perception quality. In addition, the hazard and risk analysis system may reset the distribution data on a pre-defined basis (e.g., start a new distribution) in order to prevent historical perception data from masking more recent perception degradation (e.g., recent “bad” sensor readings may not be visible in the data when too much “good” data is already present). As should be appreciated, the time period for resetting the distribution may depend on the frame rate, and may require frequent resets (e.g., hours, days) for high frame rates or less frequent resets for lower frame rates (e.g., weeks, months, etc.).

In comparison to the complexity that may be involved in estimating perception quality rating and perception errors, estimating the situational probability (e.g., the likelihood the vehicle will find itself in a hazardous situation) or the policy error rate (e.g., the likelihood of a failure of the decision and/or control system of the vehicle) may be less complex because these types of metrics may be directly measured (e.g., without a need to check against ground truth). The operational information may be observed while the vehicle is operating, and the hazard and risk analysis system may directly determine the associated distributions to be used for estimating the situational probability or the policy error rate.

As one example of how operational information may be used to estimate situational probability, one distribution that may be observed from operational information is how often the vehicle observes a leading vehicle performing a braking maneuver. This observed information may then be compared to baseline values (e.g., from pre-deployment estimates, crowd-sourced historical data, or other non-vehicle specific sources) for the probability of a braking maneuver by a leading vehicle in the given situation). For example, FIG. 7 shows an exemplary baseline probability distribution at various speeds of whether the leading car will likely decelerate (curve 710), accelerate (curve 720), or remain at a constant speed (curve 730). Such a distribution may be used as a baseline by the hazard and risk analysis system for evaluating a likelihood of encountering a hazardous situation, as each of these situations may be potentially hazardous for the vehicle that is following. Using a braking event of the leading vehicle as an example, and using FIG. 6 as a baseline probability distribution for the expected probability that a leading vehicle will brake (e.g., using curve 720), at speeds between 100 km/h and 130 km/h, the baseline probability would be around 2%. Thus, if the hazard and risk analysis system observes that leading vehicles brake more often than 2%, this may be an indication that the vehicle finds itself in hazardous situations more often than normal, and the hazard and risk analysis system may increase the situational probability accordingly.

As another example of how operational information may be used to estimate situational probability, one distribution that may be observed from operational information is a speed distribution, which may be compared to baseline speed distributions. As shown in FIG. 8, curve 810 may represent a baseline speed distribution probability for a vehicle, plotted across various speeds. If the observation data about the vehicle indicates that the speed distribution is considerably different from the baseline speed distribution, this may indicate that the vehicle finds itself in hazardous situations more often than normal, and the hazard and risk analysis system may increase the situational probability. As with other distributions, the difference from the observed distribution to the baseline distribution may be determined using metrics such as the Kolmogorov-Smirnov-Test or by comparing expected values, peaks, standard deviation, or other characteristics. In addition, to ensure that only high quality observational information is used to as inputs to the hazard and risk analysis system, the hazard and risk analysis system may use confidence values for the distribution to exclude observational information with low confidence. As with the distributions discussed above with respect to the perception system, the hazard and risk analysis system may reset the distribution data on a pre-defined basis (e.g., hours, days, weeks, months, etc.) in order to prevent historical data from masking data from recent observations.

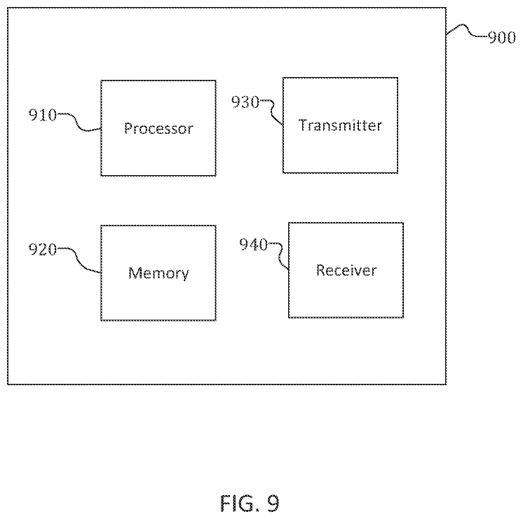

FIG. 9 shows an example of device 900 for continuously evaluating the hazard/risk safety of a vehicle using operational information of the vehicle. Without limitation, device 900 may implement any, some, and/or all of the features described above with respect to hazard and risk analysis system 200, hazard and risk analysis system 300, and/or FIGS. 1-8. FIG. 9 may be implemented as a device, a system, a method, and/or a computer readable medium that, when executed, performs any of the features of the hazard and risk analysis systems described above. It should be appreciated that device 900 is merely exemplary, and this example is not intended to limit any part of hazard and risk analysis system 200 or 300.

Device 900 includes a processor 910 configured to estimate a hazard probability for a vehicle based on operational information about the vehicle, wherein the hazard probability represents a likelihood that the vehicle will experience a driving event over a predefined interval. Processor 910 is also configured to adjust a driving parameter of the vehicle based on the hazard probability if the hazard probability deviates from a predefined hazard safety criterion. In addition to or in combination with any of the features described in this or the following paragraphs, processor 910 may be further configured to determine the hazard probability based on a situational probability of the vehicle, wherein the situational probability may represent a situational likelihood that the vehicle encounters a driving situation and/or an environmental condition requiring a change in an operational parameter. In addition to or in combination with any of the features described in this or the following paragraphs, the operational parameter may include a driving speed of the vehicle, wherein the situational probability may represent the situational likelihood as a distribution over the predefined interval of an occurrence, a magnitude, and/or a duration of the driving speed.

Furthermore, in addition to or in combination with any one of the features of this and/or the preceding paragraph with respect to device 900, the operational parameter may include a following distance of the vehicle to another vehicle, wherein the situational probability may represent the situational likelihood as a distribution over the predefined interval of an occurrence, a magnitude, and/or a duration of the following distance. Furthermore, in addition to or in combination with any one of the features of this and/or the preceding paragraph with respect to device 900, the operational parameter may include a braking event of the vehicle, wherein the situational probability may represent the situational likelihood as a distribution over the predefined interval of an occurrence, a magnitude, and/or a duration of the braking event. Furthermore, in addition to or in combination with any one of the features of this and/or the preceding paragraph with respect to device 900, the operational parameter may include an acceleration event event of the vehicle, wherein the situational probability may represent the situational likelihood as a distribution over the predefined interval of an occurrence, a magnitude, and/or a duration of the acceleration event. Furthermore, in addition to or in combination with any one of the features of this and/or the preceding paragraph with respect to device 900, the operational parameter may include a lane change event of the vehicle, wherein the situational probability may represent the situational likelihood as a distribution over the predefined interval of an occurrence, a magnitude, and/or a duration of the lane change event. Furthermore, in addition to or in combination with any one of the features of this and/or the preceding paragraph with respect to device 900, the operational parameter may include a turning event of the vehicle, wherein the situational probability may represent the situational likelihood as a distribution over the predefined interval of an occurrence, a magnitude, and/or a duration of the lane change event.

Furthermore, in addition to or in combination with any one of the features of this and/or the preceding two paragraphs with respect to device 900, processor 910 may be further configured to determine the situational likelihood based on a deviation over the predefined interval of (1) the operational parameter from an expected operational parameter of the vehicle or (2) the environmental condition from an expected environmental condition at the vehicle. Furthermore, in addition to or in combination with any one of the features of this and/or the preceding two paragraphs with respect to device 900, the expected operational parameter or the expected environmental condition may be based on an historical dataset including corresponding operational parameters and/or corresponding environmental conditions of other vehicles. Furthermore, in addition to or in combination with any one of the features of this and/or the preceding two paragraphs with respect to device 900, processor 910 may be further configured to determine the hazard probability based on a perception quality rating of a perception system of the vehicle, wherein the perception quality rating may represent an error rate of a measurement of the perception system. Furthermore, in addition to or in combination with any one of the features of this and/or the preceding two paragraphs with respect to device 900, the measurement of the perception system may include an object detection by the perception system of an object proximate the vehicle, wherein perception quality rating may represent the error rate as a distribution over the predefined interval of an occurrence, a magnitude, and/or a duration of the object detection.

Furthermore, in addition to or in combination with any one of the features of this and/or the preceding three paragraphs with respect to device 900, the measurement of the perception system may include a velocity estimate by the perception system of an object proximate the vehicle, wherein perception quality rating may represent the error rate as a distribution over the predefined interval of an occurrence, a magnitude, and/or a duration of the velocity estimate. Furthermore, in addition to or in combination with any one of the features of this and/or the preceding three paragraphs with respect to device 900, the measurement of the perception system may include a distance estimate by the perception system of an object proximate the vehicle, wherein perception quality rating may represent the error rate as a distribution over the predefined interval of an occurrence, a magnitude, and/or a duration of the distance estimate. Furthermore, in addition to or in combination with any one of the features of this and/or the preceding three paragraphs with respect to device 900, processor 910 may be further configured to determine the hazard probability based on a policy error rate of a parametric policy of the vehicle, wherein the policy error rate may represent a rate at which a driving parameter of the vehicle exceeds a predefined threshold for the driving parameter from the parametric policy.

Furthermore, in addition to or in combination with any one of the features of this and/or the preceding four paragraphs with respect to device 900, the driving parameter may include an acceleration of the vehicle and the parametric policy includes at least one of a maximum allowable acceleration of the vehicle, a minimum allowable distance to a proximate object, a maximum allowable change in acceleration, a maximum allowable braking force, an allowable technique of a lane change, and wherein the policy error rate represents the rate as a distribution over the predefined interval of an occurrence, a magnitude, and/or a duration of when the driving parameter of the vehicle exceeds the predefined threshold. Furthermore, in addition to or in combination with any one of the features of this and/or the preceding four paragraphs with respect to device 900, processor 910 may be further configured to determine the policy error rate based on a deviation over the predefined interval of the driving parameter from an expected driving parameter for the vehicle according to the parametric policy. Furthermore, in addition to or in combination with any one of the features of this and/or the preceding four paragraphs with respect to device 900, the expected driving parameter may be based on an historical dataset including corresponding driving parameters of other vehicles according to the parametric policy.

Furthermore, in addition to or in combination with any one of the features of this and/or the preceding five paragraphs with respect to device 900, processor 910 may be further configured to determine the hazard probability based on a policy error rate of a parametric policy of the vehicle, wherein the policy error rate may represent an occurrence rate at which a predicted action of an object proximate the vehicle at a given time fails to match a actual action of the object at the given time. Furthermore, in addition to or in combination with any one of the features of this and/or the preceding five paragraphs with respect to device 900, the predicted action may include a predicted deceleration behavior of the object, and wherein the actual action may include an actual deceleration of the object. Furthermore, in addition to or in combination with any one of the features of this and/or the preceding five paragraphs with respect to device 900, the predicted action may include a predicted acceleration behavior of the object, and wherein the actual action includes an actual acceleration of the object.

Furthermore, in addition to or in combination with any one of the features of this and/or the preceding six paragraphs with respect to device 900, the predicted action may include a predicted lane change behavior of the object, and wherein the actual action may include an actual lane change behavior of the object. Furthermore, in addition to or in combination with any one of the features of this and/or the preceding six paragraphs with respect to device 900, processor 910 may be further configured to determine the hazard probability based on at least one of: (1) a perception quality rating of a perception system of the vehicle, wherein the perception quality rating may represent an error rate of a measurement of the perception system; (2) a situational probability of the vehicle, wherein the situational probability may represent a situational likelihood that the vehicle encounters a driving situation and/or an environmental condition requiring a change in an operational parameter; and (3) a policy error rate of a parametric policy of the vehicle, wherein the policy error rate may represent an occurrence rate at which a driving parameter of the vehicle exceeds a predefined threshold for the driving parameter from the parametric policy.

Furthermore, in addition to or in combination with any one of the features of this and/or the preceding seven paragraphs, device 900 may further include a memory 920 configured to store at least one of the operational information, the hazard probability, the driving parameter, the predefined interval, and the predefined hazard safety criterion. Furthermore, in addition to or in combination with any one of the features of this and/or the preceding seven paragraphs with respect to device 900, the driving event may include a collision of the vehicle with another object. Furthermore, in addition to or in combination with any one of the features of this and/or the preceding seven paragraphs, device 900 may further include a memory 920 configured to store at least one of the operational information, the hazard probability, the driving parameter, the predefined interval, and the predefined hazard safety criterion. Furthermore, in addition to or in combination with any one of the features of this and/or the preceding seven paragraphs with respect to device 900, the driving parameter may include at least one of an acceleration of the vehicle, a speed of the vehicle, a turning of the vehicle, a distance between the vehicle and objects proximate to the vehicle, and a braking of the vehicle.

Furthermore, in addition to or in combination with any one of the features of this and/or the preceding eight paragraphs with respect to device 900, the operational information may include at least one of a speed of the vehicle, an acceleration of the vehicle, a trajectory of the vehicle, a pose of the vehicle, and an environmental condition of an environment around the vehicle. Furthermore, in addition to or in combination with any one of the features of this and/or the preceding eight paragraphs with respect to device 900, processor 910 may be further configured to, at a predefined interval, receive updated operational information about the vehicle, estimate the hazard probability as an updated hazard probability based on the updated operational information, and readjust the driving parameter based on the updated hazard probability. Furthermore, in addition to or in combination with any one of the features of this and/or the preceding eight paragraphs with respect to device 900, the predefined interval may include at least one of a real-time interval, a periodic time-based interval, a random interval, and an event-triggered interval.

Furthermore, in addition to or in combination with any one of the features of this and/or the preceding nine paragraphs, device 900 may further include a transmitter 930 configured to transmit the hazard probability to a server that is external to the vehicle. Furthermore, in addition to or in combination with any one of the features of this and/or the preceding nine paragraphs, device 900 may further include a receiver 940 configured to receive a status message from the vehicle containing the operational information, wherein the processor configured to adjust the driving parameter of the vehicle may include transmitter 930 configured to send a configuration message with the driving parameter to the vehicle. Furthermore, in addition to or in combination with any one of the features of this and/or the preceding nine paragraphs with respect to device 900, processor 910 configured to adjust the driving parameter of the vehicle based on the hazard probability may include processor 910 configured to select the driving parameter from a lookup table of driving parameters organized by a corresponding set of hazard probabilities and/or a corresponding set of operational information.

Furthermore, in addition to or in combination with any one of the features of this and/or the preceding ten paragraphs with respect to device 900, processor 910 configured to adjust the driving parameter of the vehicle based on the hazard probability may include the processor configured to determine the driving parameter using a learning model that outputs the driving parameter based on an input including the hazard probability and/or the operational information. Furthermore, in addition to or in combination with any one of the features of this and/or the preceding ten paragraphs with respect to device 900, a value of the driving parameter may be bounded by a maximum driving parameter value and/or a minimum driving parameter value. Furthermore, in addition to or in combination with any one of the features of this and/or the preceding ten paragraphs with respect to device 900, the error rate of the measurement of the perception system may include a difference between sensor information of at least two different sensor systems of the perception system, wherein the two different sensor systems may have an at least partially overlapping field of view.

Furthermore, in addition to or in combination with any one of the features of this and/or the preceding eleven paragraphs with respect to device 900, the at least two different sensor systems may include a first sensor system with a first modality and a second sensor system with a second modality, wherein the first modality is different from the second modality. Furthermore, in addition to or in combination with any one of the features of this and/or the preceding eleven paragraphs with respect to device 900, the first sensor system may include a camera sensor system and wherein the second sensor system may include a LiDAR sensor. Furthermore, in addition to or in combination with any one of the features of this and/or the preceding eleven paragraphs with respect to device 900, the difference may include a comparison between expected sensor information and the sensor information of the at least two different sensor systems. Furthermore, in addition to or in combination with any one of the features of this and/or the preceding eleven paragraphs with respect to device 900, the perception quality rating of the perception system may include a deviation of first perception information obtained from a first perception sensor system as compared to second perception information obtained from a second perception sensor system.

Furthermore, in addition to or in combination with any one of the features of this and/or the preceding twelve paragraphs with respect to device 900, the first perception information may include a first number of detection objects detected by the first perception sensor system in a field of view, wherein the second perception information may include a second number of detection objects detected by the second perception sensor system in the field of view. Furthermore, in addition to or in combination with any one of the features of this and/or the preceding twelve paragraphs with respect to device 900, the second perception sensor system may be redundant to the first perception sensor system. Furthermore, in addition to or in combination with any one of the features of this and/or the preceding twelve paragraphs with respect to device 900, the first perception sensor system may use a first sensor type that is different to a second sensor type of the second perception sensor system. Furthermore, in addition to or in combination with any one of the features of this and/or the preceding twelve paragraphs with respect to device 900, the predefined hazard safety criterion may include a target level of compliance with an automated driving safety standard. Furthermore, in addition to or in combination with any one of the features of this and/or the preceding twelve paragraphs with respect to device 900, processor 910 may be further configured to adjust the driving parameter of the vehicle based on the hazard probability if the hazard probability deviates from the predefined hazard safety criterion by a threshold deviation.

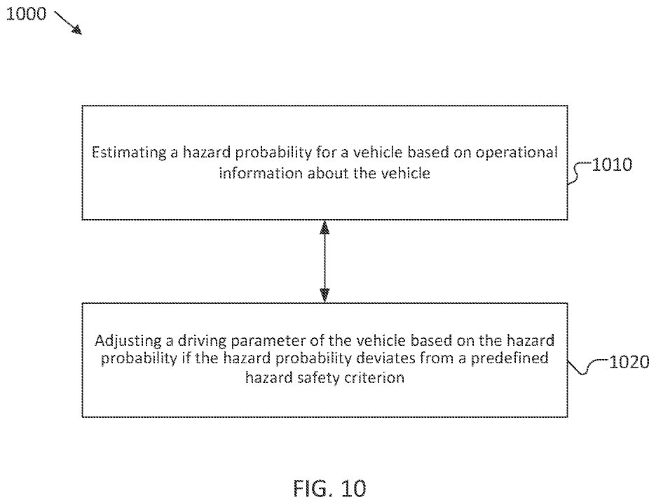

FIG. 10 depicts a schematic flow diagram of a method 1000 for continuously evaluating the hazard/risk safety of a vehicle using operational information of the vehicle. Method 1000 may implement any of the features discussed above with respect to hazard and risk analysis system 200, hazard and risk analysis system 300, device 900, and/or FIGS. 1-9).

Method 1000 includes, in 1010, estimating a hazard probability for a vehicle based on operational information about the vehicle, wherein the hazard probability represents a likelihood that the vehicle will experience a driving event over a predefined interval. The method also includes, in 1020, adjusting a driving parameter of the vehicle based on the hazard probability if the hazard probability deviates from a predefined hazard safety criterion.

In the following, various examples are provided that may include one or more aspects described above with reference to features of the disclosed evaluation system (e.g., with respect to evaluation system 100, evaluation system 200, device 400, method 500, and/or FIGS 1-5). The examples provided in relation to the devices may apply also to the described method(s), and vice versa.

Example 1 is a device including a processor configured to estimate a hazard probability for a vehicle based on operational information about the vehicle, wherein the hazard probability represents a likelihood that the vehicle will experience a driving event over a predefined interval. The processor is also configured to adjust a driving parameter of the vehicle based on the hazard probability if the hazard probability deviates from a predefined hazard safety criterion.

Example 2 is the device of example 1, wherein the processor is further configured to determine the hazard probability based on a situational probability of the vehicle, wherein the situational probability represents a situational likelihood that the vehicle encounters a driving situation and/or an environmental condition requiring a change in an operational parameter.

Example 3 is the device of example 2, wherein the operational parameter includes a driving speed of the vehicle, wherein the situational probability represents the situational likelihood as a distribution over the predefined interval of an occurrence, a magnitude, and/or a duration of the driving speed.

Example 4 is the device of either of examples 2 or 3, wherein the operational parameter includes a following distance of the vehicle to another vehicle, wherein the situational probability represents the situational likelihood as a distribution over the predefined interval of an occurrence, a magnitude, and/or a duration of the following distance.

Example 5 is the device of any one of examples 2 to 4, wherein the operational parameter includes a braking event of the vehicle, wherein the situational probability represents the situational likelihood as a distribution over the predefined interval of an occurrence, a magnitude, and/or a duration of the braking event.

Example 6 is the device of any one of examples 2 to 5, wherein the operational parameter includes an acceleration event event of the vehicle, wherein the situational probability represents the situational likelihood as a distribution over the predefined interval of an occurrence, a magnitude, and/or a duration of the acceleration event.

Example 7 is the device of any one of examples 2 to 6, wherein the operational parameter includes a lane change event of the vehicle, wherein the situational probability represents the situational likelihood as a distribution over the predefined interval of an occurrence, a magnitude, and/or a duration of the lane change event.

Example 8 is the device of any one of examples 2 to 7, wherein the operational parameter includes a turning event of the vehicle, wherein the situational probability represents the situational likelihood as a distribution over the predefined interval of an occurrence, a magnitude, and/or a duration of the lane change event.

Example 9 is the device of any one of examples 2 to 8, wherein the processor is further configured to determine the situational likelihood based on a deviation over the predefined interval of (1) the operational parameter from an expected operational parameter of the vehicle or (2) the environmental condition from an expected environmental condition at the vehicle.

Example 10 is the device of example 9, wherein the expected operational parameter or the expected environmental condition is based on an historical dataset including corresponding operational parameters and/or corresponding environmental conditions of other vehicles.

Example 11 is the device of any one of examples 1 to 10, wherein the processor is further configured to determine the hazard probability based on a perception quality rating of a perception system of the vehicle, wherein the perception quality rating represents an error rate of a measurement of the perception system.

Example 12 is the device of example 11, wherein the measurement of the perception system includes an object detection by the perception system of an object proximate the vehicle, wherein perception quality rating represents the error rate as a distribution over the predefined interval of an occurrence, a magnitude, and/or a duration of the object detection.

Example 13 is the device of example 11, wherein the measurement of the perception system includes a velocity estimate by the perception system of an object proximate the vehicle, wherein perception quality rating represents the error rate as a distribution over the predefined interval of an occurrence, a magnitude, and/or a duration of the velocity estimate.

Example 14 is the device of example 11, wherein the measurement of the perception system includes a distance estimate by the perception system of an object proximate the vehicle, wherein perception quality rating represents the error rate as a distribution over the predefined interval of an occurrence, a magnitude, and/or a duration of the distance estimate.

Example 15 is the device of any one of examples 1 to 14, wherein the processor is further configured to determine the hazard probability based on a policy error rate of a parametric policy of the vehicle, wherein the policy error rate represents a rate at which a driving parameter of the vehicle exceeds a predefined threshold for the driving parameter from the parametric policy.

Example 16 is the device of example 15, wherein the driving parameter includes an acceleration of the vehicle and the parametric policy includes at least one of a maximum allowable acceleration of the vehicle, a minimum allowable distance to a proximate object, a maximum allowable change in acceleration, a maximum allowable braking force, an allowable technique of a lane change, and wherein the policy error rate represents the rate as a distribution over the predefined interval of an occurrence, a magnitude, and/or a duration of when the driving parameter of the vehicle exceeds the predefined threshold.

Example 17 is the device of either of examples 15 or 16, wherein the processor is further configured to determine the policy error rate based on a deviation over the predefined interval of the driving parameter from an expected driving parameter for the vehicle according to the parametric policy.

Example 18 is the device of example 17, wherein the expected driving parameter is based on an historical dataset including corresponding driving parameters of other vehicles according to the parametric policy.

Example 19 is the device of any one of examples 1 to 18, wherein the processor is further configured to determine the hazard probability based on a policy error rate of a parametric policy of the vehicle, wherein the policy error rate represents an occurrence rate at which a predicted action of an object proximate the vehicle at a given time fails to match a actual action of the object at the given time.

Example 20 is the device of example 19, wherein the predicted action includes a predicted deceleration behavior of the object, and wherein the actual action includes an actual deceleration of the object.

Example 21 is the device of example 19, wherein the predicted action includes a predicted acceleration behavior of the object, and wherein the actual action includes an actual acceleration of the object.

Example 22 is the device of example 19, wherein the predicted action includes a predicted lane change behavior of the object, and wherein the actual action includes an actual lane change behavior of the object.

Example 23 is the device of any one of examples 1 to 22, wherein the processor is further configured to determine the hazard probability based on at least one of: (1) a perception quality rating of a perception system of the vehicle, wherein the perception quality rating represents an error rate of a measurement of the perception system; (2) a situational probability of the vehicle, wherein the situational probability represents a situational likelihood that the vehicle encounters a driving situation and/or an environmental condition requiring a change in an operational parameter; and (3) a policy error rate of a parametric policy of the vehicle, wherein the policy error rate represents an occurrence rate at which a driving parameter of the vehicle exceeds a predefined threshold for the driving parameter from the parametric policy.

Example 24 is the device of any one of examples 1 to 23, the device further including a memory configured to store at least one of the operational information, the hazard probability, the driving parameter, the predefined interval, and the predefined hazard safety criterion.

Example 25 is the device of any one of examples 1 to 24, wherein the driving event includes a collision of the vehicle with another object.

Example 26 is the device of any one of examples 1 to 25, wherein the driving parameter includes at least one of an acceleration of the vehicle, a speed of the vehicle, a turning of the vehicle, a distance between the vehicle and objects proximate to the vehicle, and a braking of the vehicle.

Example 27 is the device of any one of examples 1 to 26, wherein the operational information includes at least one of a speed of the vehicle, an acceleration of the vehicle, a trajectory of the vehicle, a pose of the vehicle, and an environmental condition of an environment around the vehicle.

Example 28 is the device of any one of examples 1 to 27, wherein the processor is further configured to, at a predefined interval, receive updated operational information about the vehicle, estimate the hazard probability as an updated hazard probability based on the updated operational information, and readjust the driving parameter based on the updated hazard probability.

Example 29 is the device of example 28, wherein the predefined interval includes at least one of a real-time interval, a periodic time-based interval, a random interval, and an event-triggered interval.

Example 30 is the device of any one of examples 1 to 29, the device further including a transmitter (or transceiver) configured to transmit the hazard probability to a server that is external to the vehicle.

Example 31 is the device of any one of examples 1 to 29, the device further including a receiver (or a transceiver) configured to receive a status message from the vehicle containing the operational information, wherein the processor configured to adjust the driving parameter of the vehicle includes a transmitter (or the transceiver) configured to send a configuration message with the driving parameter to the vehicle.

Example 32 is the device of any one of examples 1 to 31, wherein the processor configured to adjust the driving parameter of the vehicle based on the hazard probability includes the processor configured to select the driving parameter from a lookup table of driving parameters organized by a corresponding set of hazard probabilities and/or a corresponding set of operational information.

Example 33 is the device of any one of examples 1 to 32, wherein the processor configured to adjust the driving parameter of the vehicle based on the hazard probability includes the processor configured to determine the driving parameter using a learning model that outputs the driving parameter based on an input including the hazard probability and/or the operational information.

Example 34 is the device of any one of examples 1 to 33, wherein a value of the driving parameter is bounded by a maximum driving parameter value and/or a minimum driving parameter value.

Example 35 is the device of example 11, wherein the error rate of the measurement of the perception system includes a difference between sensor information of at least two different sensor systems of the perception system, wherein the two different sensor systems have an at least partially overlapping field of view.

Example 36 is the device of example 35, wherein the at least two different sensor systems include a first sensor system with a first modality and a second sensor system with a second modality, wherein the first modality is different from the second modality.

Example 37 is the device of example 36, wherein the first sensor system includes a camera sensor system and wherein the second sensor system includes a LiDAR sensor.

Example 38 is the device of any one of examples 35 to 37, wherein the difference includes a comparison between expected sensor information and the sensor information of the at least two different sensor systems.

Example 39 is the device of any one of examples 1 to 38, wherein the perception quality rating of the perception system includes a deviation of first perception information obtained from a first perception sensor system as compared to second perception information obtained from a second perception sensor system.

Example 40 is the device of example 39, wherein the first perception information includes a first number of detection objects detected by the first perception sensor system in a field of view, wherein the second perception information includes a second number of detection objects detected by the second perception sensor system in the field of view.

Example 41 is the device of either one of examples 39 or 40, wherein the second perception sensor system is redundant to the first perception sensor system.

Example 42 is the device of either one of examples 39 or 41, wherein the first perception sensor system uses a first sensor type that is different to a second sensor type of the second perception sensor system.

Example 43 is the device of any one of examples 1 to 42, wherein the predefined hazard safety criterion includes a target level of compliance with an automated driving safety standard.

Example 44 is the device of any one of examples 1 to 43, wherein the processor is further configured to adjust the driving parameter of the vehicle based on the hazard probability if the hazard probability deviates from the predefined hazard safety criterion by a threshold deviation.

Example 45 is a method that includes estimating a hazard probability for a vehicle based on operational information about the vehicle, wherein the hazard probability represents a likelihood that the vehicle will experience a driving event over a predefined interval. The method also includes adjusting a driving parameter of the vehicle based on the hazard probability if the hazard probability deviates from a predefined hazard safety criterion.

Example 46 is the method of example 45, wherein the method further includes determining the hazard probability based on a situational probability of the vehicle, wherein the situational probability represents a situational likelihood that the vehicle encounters a driving situation and/or an environmental condition requiring a change in an operational parameter.

Example 47 is the method of example 46, wherein the operational parameter includes a driving speed of the vehicle, wherein the situational probability represents the situational likelihood as a distribution over the predefined interval of an occurrence, a magnitude, and/or a duration of the driving speed.

Example 48 is the method of either of examples 46 or 47, wherein the operational parameter includes a following distance of the vehicle to another vehicle, wherein the situational probability represents the situational likelihood as a distribution over the predefined interval of an occurrence, a magnitude, and/or a duration of the following distance.

Example 49 is the method of any one of examples 46 to 48, wherein the operational parameter includes a braking event of the vehicle, wherein the situational probability represents the situational likelihood as a distribution over the predefined interval of an occurrence, a magnitude, and/or a duration of the braking event.

Example 50 is the method of any one of examples 46 to 49, wherein the operational parameter includes an acceleration event event of the vehicle, wherein the situational probability represents the situational likelihood as a distribution over the predefined interval of an occurrence, a magnitude, and/or a duration of the acceleration event.

Example 51 is the method of any one of examples 46 to 50, wherein the operational parameter includes a lane change event of the vehicle, wherein the situational probability represents the situational likelihood as a distribution over the predefined interval of an occurrence, a magnitude, and/or a duration of the lane change event.

Example 52 is the method of any one of examples 46 to 51, wherein the operational parameter includes a turning event of the vehicle, wherein the situational probability represents the situational likelihood as a distribution over the predefined interval of an occurrence, a magnitude, and/or a duration of the lane change event.

Example 53 is the method of any one of examples 46 to 52, wherein the method further includes determining the situational likelihood based on a deviation over the predefined interval of (1) the operational parameter from an expected operational parameter of the vehicle or (2) the environmental condition from an expected environmental condition at the vehicle.

Example 54 is the method of example 53, wherein the expected operational parameter or the expected environmental condition is based on an historical dataset including corresponding operational parameters and/or corresponding environmental conditions of other vehicles.

Example 55 is the method of any one of examples 45 to 54, wherein the method further includes determining the hazard probability based on a perception quality rating of a perception system of the vehicle, wherein the perception quality rating represents an error rate of a measurement of the perception system.

Example 56 is the method of example 55, wherein the measurement of the perception system includes an object detection by the perception system of an object proximate the vehicle, wherein perception quality rating represents the error rate as a distribution over the predefined interval of an occurrence, a magnitude, and/or a duration of the object detection.

Example 57 is the method of example 55, wherein the measurement of the perception system includes a velocity estimate by the perception system of an object proximate the vehicle, wherein perception quality rating represents the error rate as a distribution over the predefined interval of an occurrence, a magnitude, and/or a duration of the velocity estimate.

Example 58 is the method of example 55, wherein the measurement of the perception system includes a distance estimate by the perception system of an object proximate the vehicle, wherein perception quality rating represents the error rate as a distribution over the predefined interval of an occurrence, a magnitude, and/or a duration of the distance estimate.

Example 59 is the method of any one of examples 45 to 58, wherein the method further includes determining the hazard probability based on a policy error rate of a parametric policy of the vehicle, wherein the policy error rate represents a rate at which a driving parameter of the vehicle exceeds a predefined threshold for the driving parameter from the parametric policy.

Example 60 is the method of example 59, wherein the driving parameter includes an acceleration of the vehicle and the parametric policy includes at least one of a maximum allowable acceleration of the vehicle, a minimum allowable distance to a proximate object, a maximum allowable change in acceleration, a maximum allowable braking force, an allowable technique of a lane change, and wherein the policy error rate represents the rate as a distribution over the predefined interval of an occurrence, a magnitude, and/or a duration of when the driving parameter of the vehicle exceeds the predefined threshold.

Example 61 is the method of either of examples 59 or 60, wherein the method further includes determining the policy error rate based on a deviation over the predefined interval of the driving parameter from an expected driving parameter for the vehicle according to the parametric policy.

Example 62 is the method of example 61, wherein the expected driving parameter is based on an historical dataset including corresponding driving parameters of other vehicles according to the parametric policy.

Example 63 is the method of any one of examples 45 to 62, wherein the method further includes determining the hazard probability based on a policy error rate of a parametric policy of the vehicle, wherein the policy error rate represents an occurrence rate at which a predicted action of an object proximate the vehicle at a given time fails to match a actual action of the object at the given time.

Example 64 is the method of example 63, wherein the predicted action includes a predicted deceleration behavior of the object, and wherein the actual action includes an actual deceleration of the object.

Example 65 is the method of example 63, wherein the predicted action includes a predicted acceleration behavior of the object, and wherein the actual action includes an actual acceleration of the object.

Example 66 is the method of example 63, wherein the predicted action includes a predicted lane change behavior of the object, and wherein the actual action includes an actual lane change behavior of the object.

Example 67 is the method of any one of examples 45 to 66, wherein the method further includes determining the hazard probability based on at least one of: (1) a perception quality rating of a perception system of the vehicle, wherein the perception quality rating represents an error rate of a measurement of the perception system; (2) a situational probability of the vehicle, wherein the situational probability represents a situational likelihood that the vehicle encounters a driving situation and/or an environmental condition requiring a change in an operational parameter; and (3) a policy error rate of a parametric policy of the vehicle, wherein the policy error rate represents an occurrence rate at which a driving parameter of the vehicle exceeds a predefined threshold for the driving parameter from the parametric policy.

Example 68 is the method of any one of examples 45 to 67, the method further including storing (e.g., in a memory) at least one of the operational information, the hazard probability, the driving parameter, the predefined interval, and the predefined hazard safety criterion.

Example 69 is the method of any one of examples 45 to 68, wherein the driving event includes a collision of the vehicle with another object.

Example 70 is the method of any one of examples 45 to 69, wherein the driving parameter includes at least one of an acceleration of the vehicle, a speed of the vehicle, a turning of the vehicle, a distance between the vehicle and objects proximate to the vehicle, and a braking of the vehicle.

Example 71 is the method of any one of examples 45 to 70, wherein the operational information includes at least one of a speed of the vehicle, an acceleration of the vehicle, a trajectory of the vehicle, a pose of the vehicle, and an environmental condition of an environment around the vehicle.

Example 72 is the method of any one of examples 45 to 71, wherein the method further includes, at a predefined interval, receiving updated operational information about the vehicle, estimating the hazard probability as an updated hazard probability based on the updated operational information, and readjusting the driving parameter based on the updated hazard probability.

Example 73 is the method of example 72, wherein the predefined interval includes at least one of a real-time interval, a periodic time-based interval, a random interval, and an event-triggered interval.

Example 74 is the method of any one of examples 45 to 73, the method further including transmitting (e.g., via a transmitter or transceiver) the hazard probability to a server that is external to the vehicle.

Example 75 is the method of any one of examples 45 to 73, the method further including receiving (e.g., via a receiver or transceiver) a status message from the vehicle containing the operational information, wherein the adjusting the driving parameter of the vehicle includes sending a configuration message with the driving parameter to the vehicle.

Example 76 is the method of any one of examples 45 to 75, wherein the adjusting the driving parameter of the vehicle based on the hazard probability includes selecting the driving parameter from a lookup table of driving parameters organized by a corresponding set of hazard probabilities and/or a corresponding set of operational information.

Example 77 is the method of any one of examples 45 to 76, wherein the adjusting the driving parameter of the vehicle based on the hazard probability includes determining the driving parameter using a learning model that outputs the driving parameter based on an input including the hazard probability and/or the operational information.

Example 78 is the method of any one of examples 45 to 77, wherein a value of the driving parameter is bounded by a maximum driving parameter value and/or a minimum driving parameter value.

Example 79 is the method of example 55, wherein the error rate of the measurement of the perception system includes a difference between sensor information of at least two different sensor systems of the perception system, wherein the two different sensor systems have an at least partially overlapping field of view.

Example 80 is the method of example 79, wherein the at least two different sensor systems include a first sensor system with a first modality and a second sensor system with a second modality, wherein the first modality is different from the second modality.

Example 81 is the method of example 80, wherein the first sensor system includes a camera sensor system and wherein the second sensor system includes a LiDAR sensor.

Example 82 is the method of any one of examples 79 to 81, wherein the difference includes a comparison between expected sensor information and the sensor information of the at least two different sensor systems.

Example 83 is the method of any one of examples 45 to 82, wherein the perception quality rating of the perception system includes a deviation of first perception information obtained from a first perception sensor system as compared to second perception information obtained from a second perception sensor system.

Example 84 is the method of example 83, wherein the first perception information includes a first number of detection objects detected by the first perception sensor system in a field of view, wherein the second perception information includes a second number of detection objects detected by the second perception sensor system in the field of view.

Example 85 is the method of either one of examples 83 or 84, wherein the second perception sensor system is redundant to the first perception sensor system.

Example 86 is the method of either one of examples 83 or 85, wherein the first perception sensor system uses a first sensor type that is different to a second sensor type of the second perception sensor system.

Example 87 is the method of any one of examples 45 to 86, wherein the predefined hazard safety criterion includes a target level of compliance with an automated driving safety standard.

Example 88 is the method of any one of examples 45 to 87, wherein the method further includes adjusting the driving parameter of the vehicle based on the hazard probability if the hazard probability deviates from the predefined hazard safety criterion by a threshold deviation.

Example 89 is a device including a means for estimating a hazard probability for a vehicle based on operational information about the vehicle, wherein the hazard probability represents a likelihood that the vehicle will experience a driving event over a predefined interval. The device also includes a means for adjusting a driving parameter of the vehicle based on the hazard probability if the hazard probability deviates from a predefined hazard safety criterion.

Example 90 is the device of example 89, the device further including a means for determining the hazard probability based on a situational probability of the vehicle, wherein the situational probability represents a situational likelihood that the vehicle encounters a driving situation and/or an environmental condition requiring a change in an operational parameter.

Example 91 is the device of example 90, wherein the operational parameter includes a driving speed of the vehicle, wherein the situational probability represents the situational likelihood as a distribution over the predefined interval of an occurrence, a magnitude, and/or a duration of the driving speed.

Example 92 is the device of either of examples 90 or 91, wherein the operational parameter includes a following distance of the vehicle to another vehicle, wherein the situational probability represents the situational likelihood as a distribution over the predefined interval of an occurrence, a magnitude, and/or a duration of the following distance.

Example 93 is the device of any one of examples 90 to 92, wherein the operational parameter includes a braking event of the vehicle, wherein the situational probability represents the situational likelihood as a distribution over the predefined interval of an occurrence, a magnitude, and/or a duration of the braking event.

Example 94 is the device of any one of examples 90 to 93, wherein the operational parameter includes an acceleration event event of the vehicle, wherein the situational probability represents the situational likelihood as a distribution over the predefined interval of an occurrence, a magnitude, and/or a duration of the acceleration event.

Example 95 is the device of any one of examples 90 to 94, wherein the operational parameter includes a lane change event of the vehicle, wherein the situational probability represents the situational likelihood as a distribution over the predefined interval of an occurrence, a magnitude, and/or a duration of the lane change event.

Example 96 is the device of any one of examples 90 to 95, wherein the operational parameter includes a turning event of the vehicle, wherein the situational probability represents the situational likelihood as a distribution over the predefined interval of an occurrence, a magnitude, and/or a duration of the lane change event.

Example 97 is the device of any one of examples 90 to 96, the device further including a means for determining the situational likelihood based on a deviation over the predefined interval of (1) the operational parameter from an expected operational parameter of the vehicle or (2) the environmental condition from an expected environmental condition at the vehicle.

Example 98 is the device of example 97, wherein the expected operational parameter or the expected environmental condition is based on an historical dataset including corresponding operational parameters and/or corresponding environmental conditions of other vehicles.

Example 99 is the device of any one of examples 89 to 98, the device further including a means for determining the hazard probability based on a perception quality rating of a perception system of the vehicle, wherein the perception quality rating represents an error rate of a measurement of the perception system.

Example 100 is the device of example 99, wherein the measurement of the perception system includes an object detection by the perception system of an object proximate the vehicle, wherein perception quality rating represents the error rate as a distribution over the predefined interval of an occurrence, a magnitude, and/or a duration of the object detection.

Example 101 is the device of example 99, wherein the measurement of the perception system includes a velocity estimate by the perception system of an object proximate the vehicle, wherein perception quality rating represents the error rate as a distribution over the predefined interval of an occurrence, a magnitude, and/or a duration of the velocity estimate.

Example 102 is the device of example 99, wherein the measurement of the perception system includes a distance estimate by the perception system of an object proximate the vehicle, wherein perception quality rating represents the error rate as a distribution over the predefined interval of an occurrence, a magnitude, and/or a duration of the distance estimate.

Example 103 is the device of any one of examples 89 to 102, the device further including a means for determining the hazard probability based on a policy error rate of a parametric policy of the vehicle, wherein the policy error rate represents a rate at which a driving parameter of the vehicle exceeds a predefined threshold for the driving parameter from the parametric policy.

Example 104 is the device of example 103, wherein the driving parameter includes an acceleration of the vehicle and the parametric policy includes at least one of a maximum allowable acceleration of the vehicle, a minimum allowable distance to a proximate object, a maximum allowable change in acceleration, a maximum allowable braking force, an allowable technique of a lane change, and wherein the policy error rate represents the rate as a distribution over the predefined interval of an occurrence, a magnitude, and/or a duration of when the driving parameter of the vehicle exceeds the predefined threshold.

Example 105 is the device of either of examples 103 or 104, the device further including a means for determining the policy error rate based on a deviation over the predefined interval of the driving parameter from an expected driving parameter for the vehicle according to the parametric policy.

Example 106 is the device of example 105, wherein the expected driving parameter is based on an historical dataset including corresponding driving parameters of other vehicles according to the parametric policy.

Example 107 is the device of any one of examples 89 to 106, the device further including a means for determining the hazard probability based on a policy error rate of a parametric policy of the vehicle, wherein the policy error rate represents an occurrence rate at which a predicted action of an object proximate the vehicle at a given time fails to match a actual action of the object at the given time.

Example 108 is the device of example 107, wherein the predicted action includes a predicted deceleration behavior of the object, and wherein the actual action includes an actual deceleration of the object.

Example 109 is the device of example 107, wherein the predicted action includes a predicted acceleration behavior of the object, and wherein the actual action includes an actual acceleration of the object.

Example 110 is the device of example 107, wherein the predicted action includes a predicted lane change behavior of the object, and wherein the actual action includes an actual lane change behavior of the object.

Example 111 is the device of any one of examples 89 to 110, the device further including a means for determining the hazard probability based on at least one of: (1) a perception quality rating of a perception system of the vehicle, wherein the perception quality rating represents an error rate of a measurement of the perception system; (2) a situational probability of the vehicle, wherein the situational probability represents a situational likelihood that the vehicle encounters a driving situation and/or an environmental condition requiring a change in an operational parameter; and (3) a policy error rate of a parametric policy of the vehicle, wherein the policy error rate represents an occurrence rate at which a driving parameter of the vehicle exceeds a predefined threshold for the driving parameter from the parametric policy.

Example 112 is the device of any one of examples 89 to 111, the device further including a means for storing at least one of the operational information, the hazard probability, the driving parameter, the predefined interval, and the predefined hazard safety criterion.

Example 113 is the device of any one of examples 89 to 112, wherein the driving event includes a collision of the vehicle with another object.

Example 114 is the device of any one of examples 89 to 113, wherein the driving parameter includes at least one of an acceleration of the vehicle, a speed of the vehicle, a turning of the vehicle, a distance between the vehicle and objects proximate to the vehicle, and a braking of the vehicle.

Example 115 is the device of any one of examples 89 to 114, wherein the operational information includes at least one of a speed of the vehicle, an acceleration of the vehicle, a trajectory of the vehicle, a pose of the vehicle, and an environmental condition of an environment around the vehicle.

Example 116 is the device of any one of examples 89 to 115, the device further including a means for receiving, at a predefined interval, updated operational information about the vehicle. The device also includes a means for estimating, at the predefined interval, the hazard probability as an updated hazard probability based on the updated operational information. The device also includes a means for readjusting, at the predefined interval, the driving parameter based on the updated hazard probability.

Example 117 is the device of example 116, wherein the predefined interval includes at least one of a real-time interval, a periodic time-based interval, a random interval, and an event-triggered interval.

Example 118 is the device of any one of examples 89 to 117, the device further including a means for transmitting the hazard probability to a server that is external to the vehicle.

Example 119 is the device of any one of examples 89 to 117, the device further including a means for receiving a status message from the vehicle containing the operational information, wherein the means for adjusting the driving parameter of the vehicle includes a means for transmitting a configuration message with the driving parameter to the vehicle.

Example 120 is the device of any one of examples 89 to 119, wherein the means for adjusting the driving parameter of the vehicle based on the hazard probability includes a means for selecting the driving parameter from a lookup table of driving parameters organized by a corresponding set of hazard probabilities and/or a corresponding set of operational information.

Example 121 is the device of any one of examples 89 to 120, wherein the means for adjusting the driving parameter of the vehicle based on the hazard probability includes a means for determining the driving parameter using a learning model that outputs the driving parameter based on an input including the hazard probability and/or the operational information.

Example 122 is the device of any one of examples 89 to 121, wherein a value of the driving parameter is bounded by a maximum driving parameter value and/or a minimum driving parameter value.

Example 123 is the device of example 99, wherein the error rate of the measurement of the perception system includes a difference between sensor information of at least two different sensor systems of the perception system, wherein the two different sensor systems have an at least partially overlapping field of view.

Example 124 is the device of example 123, wherein the at least two different sensor systems include a first sensor system with a first modality and a second sensor system with a second modality, wherein the first modality is different from the second modality.

Example 125 is the device of example 124, wherein the first sensor system includes a camera sensor system and wherein the second sensor system includes a LiDAR sensor.

Example 126 is the device of any one of examples 123 to 125, wherein the difference includes a comparison between expected sensor information and the sensor information of the at least two different sensor systems.

Example 127 is the device of any one of examples 89 to 126, wherein the perception quality rating of the perception system includes a deviation of first perception information obtained from a first perception sensor system as compared to second perception information obtained from a second perception sensor system.

Example 128 is the device of example 127, wherein the first perception information includes a first number of detection objects detected by the first perception sensor system in a field of view, wherein the second perception information includes a second number of detection objects detected by the second perception sensor system in the field of view.

Example 129 is the device of either one of examples 127 or 128, wherein the second perception sensor system is redundant to the first perception sensor system.

Example 130 is the device of either one of examples 127 or 129, wherein the first perception sensor system uses a first sensor type that is different to a second sensor type of the second perception sensor system.

Example 131 is the device of any one of examples 89 to 130, wherein the predefined hazard safety criterion includes a target level of compliance with an automated driving safety standard.

Example 132 is the device of any one of examples 89 to 131, the device further including a means for adjusting the driving parameter of the vehicle based on the hazard probability if the hazard probability deviates from the predefined hazard safety criterion by a threshold deviation.

Example 133 is a non-transitory computer readable medium that includes instructions which, if executed, cause one or more processors to estimate a hazard probability for a vehicle based on operational information about the vehicle, wherein the hazard probability represents a likelihood that the vehicle will experience a driving event over a predefined interval. The instructions also cause the one or more processors to adjust a driving parameter of the vehicle based on the hazard probability if the hazard probability deviates from a predefined hazard safety criterion.

Example 134 is the non-transitory computer readable medium of example 133, wherein the instructions further cause the one or processors to determine the hazard probability based on a situational probability of the vehicle, wherein the situational probability represents a situational likelihood that the vehicle encounters a driving situation and/or an environmental condition requiring a change in an operational parameter.

Example 135 is the non-transitory computer readable medium of example 134, wherein the operational parameter includes a driving speed of the vehicle, wherein the situational probability represents the situational likelihood as a distribution over the predefined interval of an occurrence, a magnitude, and/or a duration of the driving speed.

Example 136 is the non-transitory computer readable medium of either of examples 134 or 135, wherein the operational parameter includes a following distance of the vehicle to another vehicle, wherein the situational probability represents the situational likelihood as a distribution over the predefined interval of an occurrence, a magnitude, and/or a duration of the following distance.

Example 137 is the non-transitory computer readable medium of any one of examples 134 to 136, wherein the operational parameter includes a braking event of the vehicle, wherein the situational probability represents the situational likelihood as a distribution over the predefined interval of an occurrence, a magnitude, and/or a duration of the braking event.

Example 138 is the non-transitory computer readable medium of any one of examples 134 to 137, wherein the operational parameter includes an acceleration event event of the vehicle, wherein the situational probability represents the situational likelihood as a distribution over the predefined interval of an occurrence, a magnitude, and/or a duration of the acceleration event.

Example 139 is the non-transitory computer readable medium of any one of examples 134 to 138, wherein the operational parameter includes a lane change event of the vehicle, wherein the situational probability represents the situational likelihood as a distribution over the predefined interval of an occurrence, a magnitude, and/or a duration of the lane change event.

Example 140 is the non-transitory computer readable medium of any one of examples 134 to 139, wherein the operational parameter includes a turning event of the vehicle, wherein the situational probability represents the situational likelihood as a distribution over the predefined interval of an occurrence, a magnitude, and/or a duration of the lane change event.

Example 141 is the non-transitory computer readable medium of any one of examples 134 to 140, wherein the instructions further cause the one or processors to determine the situational likelihood based on a deviation over the predefined interval of (1) the operational parameter from an expected operational parameter of the vehicle or (2) the environmental condition from an expected environmental condition at the vehicle.

Example 142 is the non-transitory computer readable medium of example 141, wherein the expected operational parameter or the expected environmental condition is based on an historical dataset including corresponding operational parameters and/or corresponding environmental conditions of other vehicles.

Example 143 is the non-transitory computer readable medium of any one of examples 133 to 142, wherein the instructions further cause the one or processors to determine the hazard probability based on a perception quality rating of a perception system of the vehicle, wherein the perception quality rating represents an error rate of a measurement of the perception system.

Example 144 is the non-transitory computer readable medium of example 143, wherein the measurement of the perception system includes an object detection by the perception system of an object proximate the vehicle, wherein perception quality rating represents the error rate as a distribution over the predefined interval of an occurrence, a magnitude, and/or a duration of the object detection.

Example 145 is the non-transitory computer readable medium of example 143, wherein the measurement of the perception system includes a velocity estimate by the perception system of an object proximate the vehicle, wherein perception quality rating represents the error rate as a distribution over the predefined interval of an occurrence, a magnitude, and/or a duration of the velocity estimate.

Example 146 is the non-transitory computer readable medium of example 143, wherein the measurement of the perception system includes a distance estimate by the perception system of an object proximate the vehicle, wherein perception quality rating represents the error rate as a distribution over the predefined interval of an occurrence, a magnitude, and/or a duration of the distance estimate.

Example 147 is the non-transitory computer readable medium of any one of examples 133 to 146, wherein the instructions further cause the one or processors to determine the hazard probability based on a policy error rate of a parametric policy of the vehicle, wherein the policy error rate represents a rate at which a driving parameter of the vehicle exceeds a predefined threshold for the driving parameter from the parametric policy.

Example 148 is the non-transitory computer readable medium of example 147, wherein the driving parameter includes an acceleration of the vehicle and the parametric policy includes at least one of a maximum allowable acceleration of the vehicle, a minimum allowable distance to a proximate object, a maximum allowable change in acceleration, a maximum allowable braking force, an allowable technique of a lane change, and wherein the policy error rate represents the rate as a distribution over the predefined interval of an occurrence, a magnitude, and/or a duration of when the driving parameter of the vehicle exceeds the predefined threshold.

Example 149 is the non-transitory computer readable medium of either of examples 147 or 148, wherein the instructions further cause the one or processors to determine the policy error rate based on a deviation over the predefined interval of the driving parameter from an expected driving parameter for the vehicle according to the parametric policy.

Example 150 is the non-transitory computer readable medium of example 149, wherein the expected driving parameter is based on an historical dataset including corresponding driving parameters of other vehicles according to the parametric policy.

Example 151 is the non-transitory computer readable medium of any one of examples 133 to 150, wherein the instructions further cause the one or processors to determine the hazard probability based on a policy error rate of a parametric policy of the vehicle, wherein the policy error rate represents an occurrence rate at which a predicted action of an object proximate the vehicle at a given time fails to match a actual action of the object at the given time.

Example 152 is the non-transitory computer readable medium of example 151, wherein the predicted action includes a predicted deceleration behavior of the object, and wherein the actual action includes an actual deceleration of the object.

Example 153 is the non-transitory computer readable medium of example 151, wherein the predicted action includes a predicted acceleration behavior of the object, and wherein the actual action includes an actual acceleration of the object.

Example 154 is the non-transitory computer readable medium of example 151, wherein the predicted action includes a predicted lane change behavior of the object, and wherein the actual action includes an actual lane change behavior of the object.

Example 155 is the non-transitory computer readable medium of any one of examples 133 to 154, wherein the instructions further cause the one or processors to determine the hazard probability based on at least one of: (1) a perception quality rating of a perception system of the vehicle, wherein the perception quality rating represents an error rate of a measurement of the perception system; (2) a situational probability of the vehicle, wherein the situational probability represents a situational likelihood that the vehicle encounters a driving situation and/or an environmental condition requiring a change in an operational parameter; and (3) a policy error rate of a parametric policy of the vehicle, wherein the policy error rate represents an occurrence rate at which a driving parameter of the vehicle exceeds a predefined threshold for the driving parameter from the parametric policy.

Example 156 is the non-transitory computer readable medium of any one of examples 133 to 155, wherein the instructions further cause the one or processors to store (e.g., in a memory) at least one of the operational information, the hazard probability, the driving parameter, the predefined interval, and the predefined hazard safety criterion.

Example 157 is the non-transitory computer readable medium of any one of examples 133 to 156, wherein the driving event includes a collision of the vehicle with another object.

Example 158 is the non-transitory computer readable medium of any one of examples 133 to 157, wherein the driving parameter includes at least one of an acceleration of the vehicle, a speed of the vehicle, a turning of the vehicle, a distance between the vehicle and objects proximate to the vehicle, and a braking of the vehicle.

Example 159 is the non-transitory computer readable medium of any one of examples 133 to 158, wherein the operational information includes at least one of a speed of the vehicle, an acceleration of the vehicle, a trajectory of the vehicle, a pose of the vehicle, and an environmental condition of an environment around the vehicle.

Example 160 is the non-transitory computer readable medium of any one of examples 133 to 159, wherein the instructions further cause the one or processors to, at a predefined interval, receive updated operational information about the vehicle, to estimate the hazard probability as an updated hazard probability based on the updated operational information, and to readjust the driving parameter based on the updated hazard probability.

Example 161 is the non-transitory computer readable medium of example 160, wherein the predefined interval includes at least one of a real-time interval, a periodic time-based interval, a random interval, and an event-triggered interval.

Example 162 is the non-transitory computer readable medium of any one of examples 133 to 161, wherein the instructions further cause the one or processors to cause the hazard probability to be transmitted (e.g., via a transmitter or transceiver) to a server that is external to the vehicle.

Example 163 is the non-transitory computer readable medium of any one of examples 133 to 161, wherein the instructions further cause the one or processors to cause a status message to be received (e.g., via a receiver or transceiver) from the vehicle containing the operational information, wherein the instructions configured to cause the one or more processors to adjust the driving parameter of the vehicle includes the instructions configured to cause the one or more processors to cause a configuration message with the driving parameter to be transmitted (e.g., via a transmitter or transceiver) to the vehicle.

Example 164 is the non-transitory computer readable medium of any one of examples 133 to 163, wherein the instructions configured to cause the one or more processors to adjust the driving parameter of the vehicle based on the hazard probability includes the instructions configured to cause the one or more processors to select the driving parameter from a lookup table of driving parameters organized by a corresponding set of hazard probabilities and/or a corresponding set of operational information.

Example 165 is the non-transitory computer readable medium of any one of examples 133 to 164, wherein the instructions configured to cause the one or more processors to adjust the driving parameter of the vehicle based on the hazard probability includes the instructions configured to cause the one or more processors to determine the driving parameter using a learning model that outputs the driving parameter based on an input including the hazard probability and/or the operational information.

Example 166 is the non-transitory computer readable medium of any one of examples 133 to 165, wherein a value of the driving parameter is bounded by a maximum driving parameter value and/or a minimum driving parameter value.

Example 167 is the non-transitory computer readable medium of example 143, wherein the error rate of the measurement of the perception system includes a difference between sensor information of at least two different sensor systems of the perception system, wherein the two different sensor systems have an at least partially overlapping field of view.

Example 168 is the non-transitory computer readable medium of example 167, wherein the at least two different sensor systems include a first sensor system with a first modality and a second sensor system with a second modality, wherein the first modality is different from the second modality.

Example 169 is the non-transitory computer readable medium of example 168, wherein the first sensor system includes a camera sensor system and wherein the second sensor system includes a LiDAR sensor.

Example 170 is the non-transitory computer readable medium of any one of examples 167 to 169, wherein the difference includes a comparison between expected sensor information and the sensor information of the at least two different sensor systems.

Example 171 is the non-transitory computer readable medium of any one of examples 133 to 170, wherein the perception quality rating of the perception system includes a deviation of first perception information obtained from a first perception sensor system as compared to second perception information obtained from a second perception sensor system.

Example 172 is the non-transitory computer readable medium of example 171, wherein the first perception information includes a first number of detection objects detected by the first perception sensor system in a field of view, wherein the second perception information includes a second number of detection objects detected by the second perception sensor system in the field of view.

Example 173 is the non-transitory computer readable medium of either one of examples 171 or 172, wherein the second perception sensor system is redundant to the first perception sensor system.

Example 174 is the non-transitory computer readable medium of either one of examples 171 or 173, wherein the first perception sensor system uses a first sensor type that is different to a second sensor type of the second perception sensor system.

Example 175 is the non-transitory computer readable medium of any one of examples 133 to 174, wherein the predefined hazard safety criterion includes a target level of compliance with an automated driving safety standard.

Example 176 is the non-transitory computer readable medium of any one of examples 133 to 175, wherein the instructions are further configured to cause the one or more processors to adjust the driving parameter of the vehicle based on the hazard probability if the hazard probability deviates from the predefined hazard safety criterion by a threshold deviation.

Example 177 is an apparatus including an estimation circuit configured to estimate a hazard probability for a vehicle based on operational information about the vehicle, wherein the hazard probability represents a likelihood that the vehicle will experience a driving event over a predefined interval. The apparatus further includes a control circuit configured to adjust a driving parameter of the vehicle based on the hazard probability if the hazard probability deviates from a predefined hazard safety criterion.

Example 178 is the apparatus of example 177, the apparatus further including a determination circuit configured to determine the hazard probability based on a situational probability of the vehicle, wherein the situational probability represents a situational likelihood that the vehicle encounters a driving situation and/or an environmental condition requiring a change in an operational parameter.

Example 179 is the apparatus of example 178, wherein the operational parameter includes a driving speed of the vehicle, wherein the situational probability represents the situational likelihood as a distribution over the predefined interval of an occurrence, a magnitude, and/or a duration of the driving speed.

Example 180 is the apparatus of either of examples 178 or 179, wherein the operational parameter includes a following distance of the vehicle to another vehicle, wherein the situational probability represents the situational likelihood as a distribution over the predefined interval of an occurrence, a magnitude, and/or a duration of the following distance.

Example 181 is the apparatus of any one of examples 178 to 180, wherein the operational parameter includes a braking event of the vehicle, wherein the situational probability represents the situational likelihood as a distribution over the predefined interval of an occurrence, a magnitude, and/or a duration of the braking event.

Example 182 is the apparatus of any one of examples 178 to 181, wherein the operational parameter includes an acceleration event event of the vehicle, wherein the situational probability represents the situational likelihood as a distribution over the predefined interval of an occurrence, a magnitude, and/or a duration of the acceleration event.

Example 183 is the apparatus of any one of examples 178 to 182, wherein the operational parameter includes a lane change event of the vehicle, wherein the situational probability represents the situational likelihood as a distribution over the predefined interval of an occurrence, a magnitude, and/or a duration of the lane change event.

Example 184 is the apparatus of any one of examples 178 to 183, wherein the operational parameter includes a turning event of the vehicle, wherein the situational probability represents the situational likelihood as a distribution over the predefined interval of an occurrence, a magnitude, and/or a duration of the lane change event.

Example 185 is the apparatus of any one of examples 178 to 184, the apparatus further including a determination circuit configured to determine the situational likelihood based on a deviation over the predefined interval of (1) the operational parameter from an expected operational parameter of the vehicle or (2) the environmental condition from an expected environmental condition at the vehicle.

Example 186 is the apparatus of example 185, wherein the expected operational parameter or the expected environmental condition is based on an historical dataset including corresponding operational parameters and/or corresponding environmental conditions of other vehicles.

Example 187 is the apparatus of any one of examples 177 to 186, the apparatus further including a determination circuit configured to determine the hazard probability based on a perception quality rating of a perception system of the vehicle, wherein the perception quality rating represents an error rate of a measurement of the perception system.

Example 188 is the apparatus of example 187, wherein the measurement of the perception system includes an object detection by the perception system of an object proximate the vehicle, wherein perception quality rating represents the error rate as a distribution over the predefined interval of an occurrence, a magnitude, and/or a duration of the object detection.

Example 189 is the apparatus of example 187, wherein the measurement of the perception system includes a velocity estimate by the perception system of an object proximate the vehicle, wherein perception quality rating represents the error rate as a distribution over the predefined interval of an occurrence, a magnitude, and/or a duration of the velocity estimate.

Example 190 is the apparatus of example 187, wherein the measurement of the perception system includes a distance estimate by the perception system of an object proximate the vehicle, wherein perception quality rating represents the error rate as a distribution over the predefined interval of an occurrence, a magnitude, and/or a duration of the distance estimate.

Example 191 is the apparatus of any one of examples 177 to 190, the apparatus further including a determination circuit configured to determine the hazard probability based on a policy error rate of a parametric policy of the vehicle, wherein the policy error rate represents a rate at which a driving parameter of the vehicle exceeds a predefined threshold for the driving parameter from the parametric policy.

Example 192 is the apparatus of example 191, wherein the driving parameter includes an acceleration of the vehicle and the parametric policy includes at least one of a maximum allowable acceleration of the vehicle, a minimum allowable distance to a proximate object, a maximum allowable change in acceleration, a maximum allowable braking force, an allowable technique of a lane change, and wherein the policy error rate represents the rate as a distribution over the predefined interval of an occurrence, a magnitude, and/or a duration of when the driving parameter of the vehicle exceeds the predefined threshold.

Example 193 is the apparatus of either of examples 191 or 192, the apparatus further including a determination circuit configured to determine the policy error rate based on a deviation over the predefined interval of the driving parameter from an expected driving parameter for the vehicle according to the parametric policy.

Example 194 is the apparatus of example 193, wherein the expected driving parameter is based on an historical dataset including corresponding driving parameters of other vehicles according to the parametric policy.

Example 195 is the apparatus of any one of examples 177 to 194, the apparatus further including a determination circuit configured to determine the hazard probability based on a policy error rate of a parametric policy of the vehicle, wherein the policy error rate represents an occurrence rate at which a predicted action of an object proximate the vehicle at a given time fails to match a actual action of the object at the given time.

Example 196 is the apparatus of example 195, wherein the predicted action includes a predicted deceleration behavior of the object, and wherein the actual action includes an actual deceleration of the object.

Example 197 is the apparatus of example 195, wherein the predicted action includes a predicted acceleration behavior of the object, and wherein the actual action includes an actual acceleration of the object.

Example 198 is the apparatus of example 195, wherein the predicted action includes a predicted lane change behavior of the object, and wherein the actual action includes an actual lane change behavior of the object.

Example 199 is the apparatus of any one of examples 177 to 198, the apparatus further including a determination circuit configured to determine the hazard probability based on at least one of (1) a perception quality rating of a perception system of the vehicle, wherein the perception quality rating represents an error rate of a measurement of the perception system; (2) a situational probability of the vehicle, wherein the situational probability represents a situational likelihood that the vehicle encounters a driving situation and/or an environmental condition requiring a change in an operational parameter; and (3) a policy error rate of a parametric policy of the vehicle, wherein the policy error rate represents an occurrence rate at which a driving parameter of the vehicle exceeds a predefined threshold for the driving parameter from the parametric policy.

Example 200 is the apparatus of any one of examples 177 to 199, the apparatus further including a memory circuit configured to store at least one of the operational information, the hazard probability, the driving parameter, the predefined interval, and the predefined hazard safety criterion.

Example 201 is the apparatus of any one of examples 177 to 200, wherein the driving event includes a collision of the vehicle with another object.

Example 202 is the apparatus of any one of examples 177 to 201, wherein the driving parameter includes at least one of an acceleration of the vehicle, a speed of the vehicle, a turning of the vehicle, a distance between the vehicle and objects proximate to the vehicle, and a braking of the vehicle.

Example 203 is the apparatus of any one of examples 177 to 202, wherein the operational information includes at least one of a speed of the vehicle, an acceleration of the vehicle, a trajectory of the vehicle, a pose of the vehicle, and an environmental condition of an environment around the vehicle.

Example 204 is the apparatus of any one of examples 177 to 203, the apparatus further including an refresh circuit configured to, at a predefined interval, receive updated operational information about the vehicle, estimate the hazard probability as an updated hazard probability based on the updated operational information, and readjust the driving parameter based on the updated hazard probability.

Example 205 is the apparatus of example 204, wherein the predefined interval includes at least one of a real-time interval, a periodic time-based interval, a random interval, and an event-triggered interval.

Example 206 is the apparatus of any one of examples 177 to 205, the apparatus further including a transmitter (or transceiver) configured to transmit the hazard probability to a server that is external to the vehicle.

Example 207 is the apparatus of any one of examples 177 to 205, the apparatus further including a receiver (or a transceiver) configured to receive a status message from the vehicle containing the operational information, wherein the control circuit includes a transmitter (or transceiver) configured to send a configuration message with the driving parameter to the vehicle.

Example 208 is the apparatus of any one of examples 177 to 207, wherein the control circuit includes a selection circuit configured to select the driving parameter from a lookup table of driving parameters organized by a corresponding set of hazard probabilities and/or a corresponding set of operational information.

Example 209 is the apparatus of any one of examples 177 to 208, wherein the control circuit includes a determination circuit configured to determine the driving parameter using a learning model that outputs the driving parameter based on an input including the hazard probability and/or the operational information.

Example 210 is the apparatus of any one of examples 177 to 209, wherein a value of the driving parameter is bounded by a maximum driving parameter value and/or a minimum driving parameter value.

Example 211 is the apparatus of example 187, wherein the error rate of the measurement of the perception system includes a difference between sensor information of at least two different sensor systems of the perception system, wherein the two different sensor systems have an at least partially overlapping field of view.

Example 212 is the apparatus of example 211, wherein the at least two different sensor systems include a first sensor system with a first modality and a second sensor system with a second modality, wherein the first modality is different from the second modality.

Example 213 is the apparatus of example 212, wherein the first sensor system includes a camera sensor system and wherein the second sensor system includes a LiDAR sensor.

Example 214 is the apparatus of any one of examples 211 to 213, wherein the difference includes a comparison between expected sensor information and the sensor information of the at least two different sensor systems.

Example 215 is the apparatus of any one of examples 177 to 214, wherein the perception quality rating of the perception system includes a deviation of first perception information obtained from a first perception sensor system as compared to second perception information obtained from a second perception sensor system.

Example 216 is the apparatus of example 215, wherein the first perception information includes a first number of detection objects detected by the first perception sensor system in a field of view, wherein the second perception information includes a second number of detection objects detected by the second perception sensor system in the field of view.

Example 217 is the apparatus of either one of examples 215 or 216, wherein the second perception sensor system is redundant to the first perception sensor system.

Example 218 is the apparatus of either one of examples 215 or 217, wherein the first perception sensor system uses a first sensor type that is different to a second sensor type of the second perception sensor system.

Example 219 is the apparatus of any one of examples 177 to 218, wherein the predefined hazard safety criterion includes a target level of compliance with an automated driving safety standard.

Example 220 is the apparatus of any one of examples 177 to 219, wherein the control circuit is further configured to adjust the driving parameter of the vehicle based on the hazard probability if the hazard probability deviates from the predefined hazard safety criterion by a threshold deviation.

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced.

1. A device comprising a processor configured to:
estimate a hazard probability for a vehicle based on operational information about the vehicle, wherein the hazard probability represents a likelihood that the vehicle will experience a driving event over a predefined interval; and
adjust a driving parameter of the vehicle based on the hazard probability if the hazard probability deviates from a predefined hazard safety criterion.

2. The device of claim 1, wherein the processor is further configured to determine the hazard probability based on a situational probability of the vehicle, wherein the situational probability represents a situational likelihood that the vehicle encounters a driving situation or an environmental condition requiring a change in an operational parameter.

3. The device of claim 1, wherein the processor is further configured to determine the hazard probability based on a perception quality rating of a perception system of the vehicle, wherein the perception quality rating represents an error rate of a measurement of the perception system.

4. The device of claim 3, wherein the measurement of the perception system comprises an object detection by the perception system of an object proximate the vehicle, wherein perception quality rating represents the error rate as a distribution over the predefined interval of an occurrence, a magnitude, or a duration of the object detection.

5. The device of claim 1, wherein the processor is further configured to determine the hazard probability based on a policy error rate of a parametric policy of the vehicle, wherein the policy error rate represents a rate at which a driving parameter of the vehicle exceeds a predefined threshold for the driving parameter from the parametric policy.

6. The device of claim 5, wherein the driving parameter comprises an acceleration of the vehicle and the parametric policy comprises at least one of a maximum allowable acceleration of the vehicle, a minimum allowable distance to a proximate object, a maximum allowable change in acceleration, a maximum allowable braking force, an allowable technique of a lane change, and wherein the policy error rate represents the rate as a distribution over the predefined interval of an occurrence, a magnitude, and a duration of when the driving parameter of the vehicle exceeds the predefined threshold.

7. The device of claim 5, wherein the processor is further configured to determine the policy error rate based on a deviation over the predefined interval of the driving parameter from an expected driving parameter for the vehicle according to the parametric policy.

8. The device of claim 1, wherein the processor is further configured to determine the hazard probability based on a policy error rate of a parametric policy of the vehicle, wherein the policy error rate represents an occurrence rate at which a predicted action of an object proximate the vehicle at a given time fails to match a actual action of the object at the given time.

9. The device of claim 1, the device further comprising a memory configured to store at least one of the operational information, the hazard probability, the driving parameter, the predefined interval, and the predefined hazard safety criterion.

10. The device of claim 1, wherein the driving event comprises a collision of the vehicle with another object.

11. The device of claim 1, wherein the processor is further configured to, at a predefined interval:
receive updated operational information about the vehicle;
estimate the hazard probability as an updated hazard probability based on the updated operational information; and
readjust the driving parameter based on the updated hazard probability.

12. The device of claim 1, wherein the predefined hazard safety criterion comprises a target level of compliance with an automated driving safety standard.

13. The device of claim 1, wherein the processor is further configured to adjust the driving parameter of the vehicle based on the hazard probability if the hazard probability deviates from the predefined hazard safety criterion by a threshold deviation.

14. An apparatus comprising:
an estimation circuit configured to estimate a hazard probability for a vehicle based on operational information about the vehicle and a situational probability of the vehicle, wherein the hazard probability represents a likelihood that the vehicle will experience a driving event over a predefined interval, wherein the situational probability represents a situational likelihood that the vehicle encounters a driving situation or an environmental condition requiring a change in an operational parameter; and
a control circuit configured to adjust a driving parameter of the vehicle based on the hazard probability if the hazard probability deviates from a predefined hazard safety criterion.

15. The apparatus of claim 14, the apparatus further comprising a determination circuit to determine the situational likelihood based on a deviation over the predefined interval of:
the operational parameter from an expected operational parameter of the vehicle; or
the environmental condition from an expected environmental condition at the vehicle.

16. The apparatus of claim 15, wherein the expected operational parameter or the expected environmental condition is based on an historical dataset comprising corresponding operational parameters or corresponding environmental conditions of other vehicles.

17. A non-transitory computer readable medium that comprises instructions which, if executed, cause one or more processors to:
estimate a hazard probability for a vehicle based on operational information about the vehicle, wherein the hazard probability represents a likelihood that the vehicle will experience a driving event over a predefined interval;
adjust a driving parameter of the vehicle based on the hazard probability if the hazard probability deviates from a predefined hazard safety criterion.

18. The non-transitory computer readable medium of claim 17, wherein the wherein the instructions further cause the one or processors to determine the hazard probability based on at least one of:
a perception quality rating of a perception system of the vehicle, wherein the perception quality rating represents an error rate of a measurement of the perception system;
a situational probability of the vehicle, wherein the situational probability represents a situational likelihood that the vehicle encounters a driving situation or an environmental condition requiring a change in an operational parameter; and
a policy error rate of a parametric policy of the vehicle, wherein the policy error rate represents an occurrence rate at which a driving parameter of the vehicle exceeds a predefined threshold for the driving parameter from the parametric policy.

19. The non-transitory computer readable medium of claim 18, wherein the perception quality rating of the perception system comprises a deviation of first perception information obtained from a first perception sensor system as compared to second perception information obtained from a second perception sensor system.

20. The non-transitory computer readable medium of claim 19, wherein the first perception information comprises a first number of detection objects detected by the first perception sensor system in a field of view, wherein the second perception information comprises a second number of detection objects detected by the second perception sensor system in the field of view.
